(19) United States
(12) Patent Application Publication
(10) Pub. No.: US 2012/0266131 A1
(43) Pub. Date: Oct. 18, 2012

(54) AUTOMATIC PROGRAM GENERATION DEVICE, METHOD, AND COMPUTER PROGRAM

(75) Inventors: Shuhei Nojiri, Kawasaki (JP); Ryota Mibe, Sagamihara (JP); Yasunori Hashimoto, Fujisawa (JP); Sadahiro Ishikawa, Yokohama (JP); Kiyoshi Yamaguchi, Kawasaki (JP)

(73) Assignee: HITACHI, LTD., Tokyo (JP)

(21) Appl. No.: 13/368,717

(22) Filed: Feb. 8, 2012

(30) Foreign Application Priority Data
Apr. 12, 2011 (JP) 2011-088609

(51) Int. Cl. G06F 9/44

(52) U.S. Cl. 717/107

(57) ABSTRACT

The present invention is provided to apply a screen mockup developed for prototyping, without any modification, to actual product development for which the architecture differs. An automatic program generation device has: a storage part 170 for storing a screen mockup program 1720, a component setup file 1730, and execution architecture definition information 1760, a storage part 160 for storing component data, a mockup design information analysis part 110 for generating component design information from the screen mockup program 1720 and the component setup file 1730 and configuring a program execution infrastructure from the execution architecture definition information 1760, a component architecture decision part 130 for selecting on the basis of the component design information a program code fragment, which operates on the configured program execution infrastructure, and a program code generation part 140 for generating a program code from the selected program code fragment.

### CROSS-REFERENCE TO PRIOR APPLICATION

This application relates to and claims the benefit of priority from Japanese Patent Application No. 2011-088609 filed on Apr. 12, 2011, the entire disclosure of which is incorporated herein by reference.

### BACKGROUND

The present invention relates to technology for automatically generating a program, and more particularly, to technology for mockup development and for supporting the transition to real mockup product development in software and system screen prototyping.

In the development of a corporate information system, it is important that the developer acquire the requirements from the customer as efficiently and accurately as possible. Then, when evaluating a developed corporate information system, it is also important that nothing be missing or omitted from the customer-required business specifications. In addition, since the efficiency of doing business is greatly changed by the operational feel of the GUI screen and other user interface functions provided by the developed corporate information system, these interfaces are of considerable interest to the customer.

Computer capabilities have improved significantly in recent years, and a high freedom-of-expression framework called RIA (Rich Internet Applications) has also achieved penetration, further increasing customers' expectations with respect to screens. The high expressiveness of screens developed using RIA and the like have made it difficult for customers and developers to share requirements for screen behavior using documentation or paper formats.

Consequently, presenting the customer with a computer-operable mockup (a screen prototype program) as a user interface screen prototype during the development process is effective at preventing discrepancies from cropping up between the customer and the developer.

However, a prototyping mockup is simply a prototype. Also, the time that can be devoted to acquiring customer requirements in an ordinary system development process is limited, making it necessary to repeatedly provide the customer with demonstrations and to make revisions based on items pointed out as a result of these demonstrations in a short period of time.

In order to efficiently develop a mockup, technology, which uses toy program parts for reproducing only a system's animation without performing internal data processing and which makes it easy to develop a prototype that functions as realistically as possible, has been proposed. For example, Japanese Patent Application Laid-open No. 2004-302571 attempts to enhance the efficiency of screen development by extracting data and other such non-screen dynamic information from screen design information and automatically generating a program.

However, traditional methods suffer from the following problems. That is, in Japanese Patent Application Laid-open No. 2004-302571, when transitioning to real product development after mockup development has ended, the mockup (the screen program agreed upon with the customer) must be thrown out, and man-hours must be spent once again in the development of another screen for production, resulting in wasted man-hours. In so doing, the developer must extract the specifications from the mockup, once again raising fears that requirement specifications will be missed or omitted at this time.

Meanwhile, since the objectives differ in mockup development and real product development, the architectures for the execution thereof will also differ. For this reason, generally it is not possible to operate a mockup program without any modification on a production architecture.

### SUMMARY

Consequently, an object of the present invention is to apply a screen mockup developed for prototyping, without any modification, to real product development for which the architecture differs.

An automatic program generation device according to one embodiment of the present invention comprises a mockup program for displaying a screen, a component type of a component, which is invoked from the above-mentioned screen, means for storing mockup data comprising attribute data, which is configured with respect to a component of the above-mentioned component type, means for storing component data comprising the specifications of the components of multiple component types, means for generating design information of a component invoked from the above-mentioned screen based on the above-mentioned mockup data and the above-mentioned component data, means for storing information specifying an execution architecture, means for configuring a program execution infrastructure corresponding to a specified execution architecture based on information specifying the above-mentioned execution architecture, means for storing a program code fragment by program execution infrastructure, and means for generating a program code based on the above-mentioned component design information by selecting a program code fragment, which operates on the above-mentioned configured program execution infrastructure, and configuring the above-mentioned attribute data in the selected program code fragment.

In a preferred embodiment, when the information specifying the above-mentioned execution architecture does not exist, the above-mentioned program execution infrastructure may be determined based on a predetermined mockup execution architecture.

In the preferred embodiment, when a default value of an attribute value configured in a component of each component type is included in the above-mentioned component data, and the above-mentioned attribute data is not included in the above-mentioned mockup data, the above-mentioned means for generating a program code may configure the above-mentioned default value with respect to the above-mentioned selected program code fragment.

The preferred embodiment may further comprise means for extracting from the above-mentioned mockup data a description related to a function, which cannot be realized by any of multiple component types included in the above-mentioned component data. Then, the above-mentioned means for generating a program code may include the above-mentioned extracted description in a program code outputted when a component invocation from the above-mentioned screen has been executed.

The preferred embodiment may further comprise a mockup development environment for generating the above-mentioned mockup data, and a mockup review environment for operating the above-mentioned mockup program and a program code generated in accordance with the above-mentioned means for generating a program code.

According to the present invention, a screen mockup, which was developed for prototyping and has been agreed upon with the customer, can be applied without any modification to real product development, which has a different architecture. As a result of this, it becomes possible to prevent misses and omissions in customer requirement specifications and to reduce development man-hours.

### BRIEF DESCRIPTION OF THE DRAWINGS

FIG. 1 is an overall block diagram of a mockup development support system 100 related to an embodiment of the present invention;

FIG. 2 is a functional block diagram of the mockup development support system 100;

FIG. 3 is an illustration of a screen mockup program 1720;

FIG. 4 is an illustration of a component setup file 1730;

FIG. 5 is an illustration of execution architecture definition information 1760;

FIG. 6 is a mockup execution architecture A1, which is the architecture for executing a mockup;

FIG. 7 is a production execution architecture A2, which is the architecture for executing a production system;

FIG. 8 is an example of a component list 1610 showing a list of components capable of being used in this system;

FIG. 9 is an example of a component setup attribute definition 1620 comprising definition information of each component;

FIG. 10 is an example of a component code fragment group by architecture 1630;

FIG. 11 is an example of a code fragment for interface generation 1640;

FIG. 12 is a detailed functional block diagram of a mockup design information analysis part 110;

FIG. 13 is an example of a data structure 1510 extracted by a data structure extraction part 112;

FIG. 14 is an example of a trigger event 1517 extracted by a trigger event extraction part 113;

FIG. 15 is an example of configuration component setup information 1520 generated by a component setup information extraction part 114;

FIG. 16 is an example of default value-supplemented configuration component setup information 1520;

FIG. 17 is an example of configuration component setup information 1520 to which an execution architecture and a code fragment storage location have been added;

FIG. 18 is an example of execution architecture setup information 1540 generated by an execution-target architecture setup analysis part 117;

FIG. 19 is a functional configuration diagram of a component setup generation part 120 realized when a component setup generation program 120P is executed by a CPU 101;

FIG. 20 is a functional configuration diagram of a program code generation part 140 realized when a program code generation program 140P is executed by the CPU 101;

FIG. 21 is a flowchart showing the steps of an entire mockup development process using this system 100;

FIG. 22 shows an example of an input/output file when generating a program code for a prototyping execution environment;

FIG. 23 shows an example of an output file when generating a program code for real product development;

FIG. 24 is a flowchart showing the detailed steps of a program code generation process;

FIG. 25A is a flowchart showing the detailed steps of a setup information extraction process for a component included in a mockup;

FIG. 25B is a flowchart showing the detailed steps of a setup information extraction process for a component included in a mockup;

FIG. 26 is a flowchart showing the processing steps for generating a component setup according to an execution architecture; and

FIG. 27 is a diagram of a first embodiment of the present invention.

### DETAILED DESCRIPTION

A mockup development support system related to an embodiment of the present invention will be explained below by referring to the drawings. The mockup development support system related to this embodiment is an automatic program generation device for automatically generating a program code for a production system from a screen mockup program developed at prototyping time, and enables a complete transition from a screen mockup to the production system. Accordingly, objectives, such as using a mockup to prevent discrepancies between specifications agreed upon with a customer and an actually developed screen program and to reduce screen program re-development man-hours, for example, are realized by comprising a configuration or functions such as explained below.

(1) Prepare functionally equivalent components for different execution architectures beforehand;
(2) Use the execution architecture to automatically select and automatically supplement the setup of a component corresponding to developer-inputted screen mockup information;
(3) Record appended information for a function other than a component, which was prepared beforehand; and
(4) Automatically generate a program code corresponding to the execution architecture.

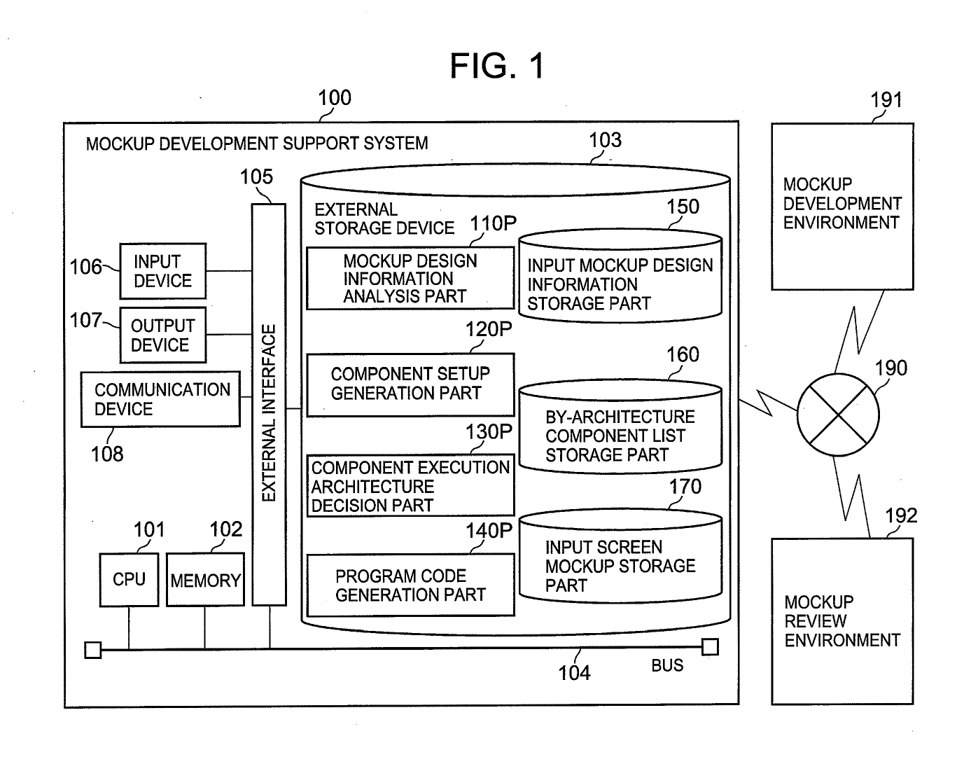

FIG. 1 is a block diagram of an entire mockup development support system 100 related to the embodiment. The system 100, as shown in the drawing, is coupled to a mockup development environment 191 and a mockup review environment 192 via a network 190. The mockup development environment 191 is a development environment for the developer to either create or revise a screen mockup. The mockup review environment 192 is an environment for operating a mockup, and is the operating environment used in a customer review. The mockup development environment 191 and the mockup review environment 192 may be incorporated in the mockup development support system 100.

The mockup development support system 100, as shown in the drawing, comprises a CPU (Central Processing Unit) 101, a memory 102, and an external interface 105, and these components are coupled together via a bus 104.

An external memory device 103, an input device 106, an output device 107, and a communication device 108 are coupled to the external interface 105.

The external storage device 103 holds a mockup design information analysis program 110P, a component setup generation program 120P, a component execution architecture decision program 130P, and a program code generation program 140P as processing programs to be executed by the CPU 101. The external storage device 103 also comprises an input mockup design information storage part 150, a by-architecture component list storage part 160, and an input screen mockup storage part 170.

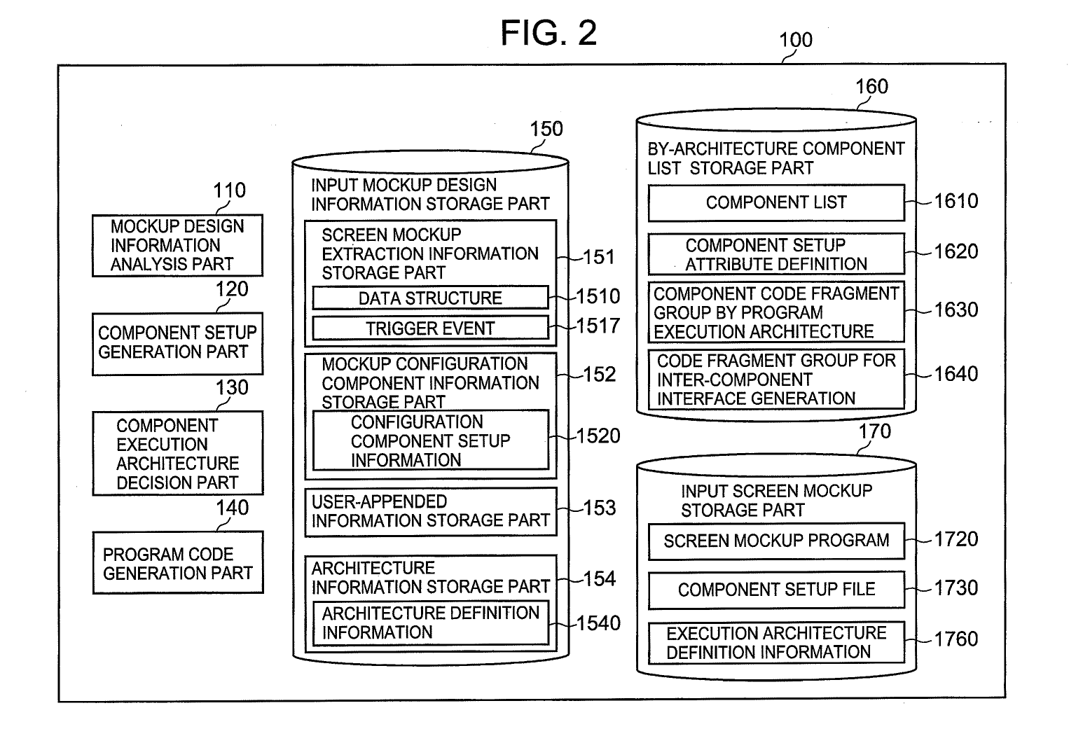

FIG. 2 shows a functional block diagram of the mockup development support system 100. The mockup design information analysis program 110P, the component setup generation program 120P, the component execution architecture decision program 130P, and the program code generation program 140P of the mockup development support system 100 respectively comprise a mockup design information analysis part 110, a component setup generation part 120, a component execution architecture decision part 130, and a program code generation part 140, which are generated in accordance with being executed by the CPU 101.

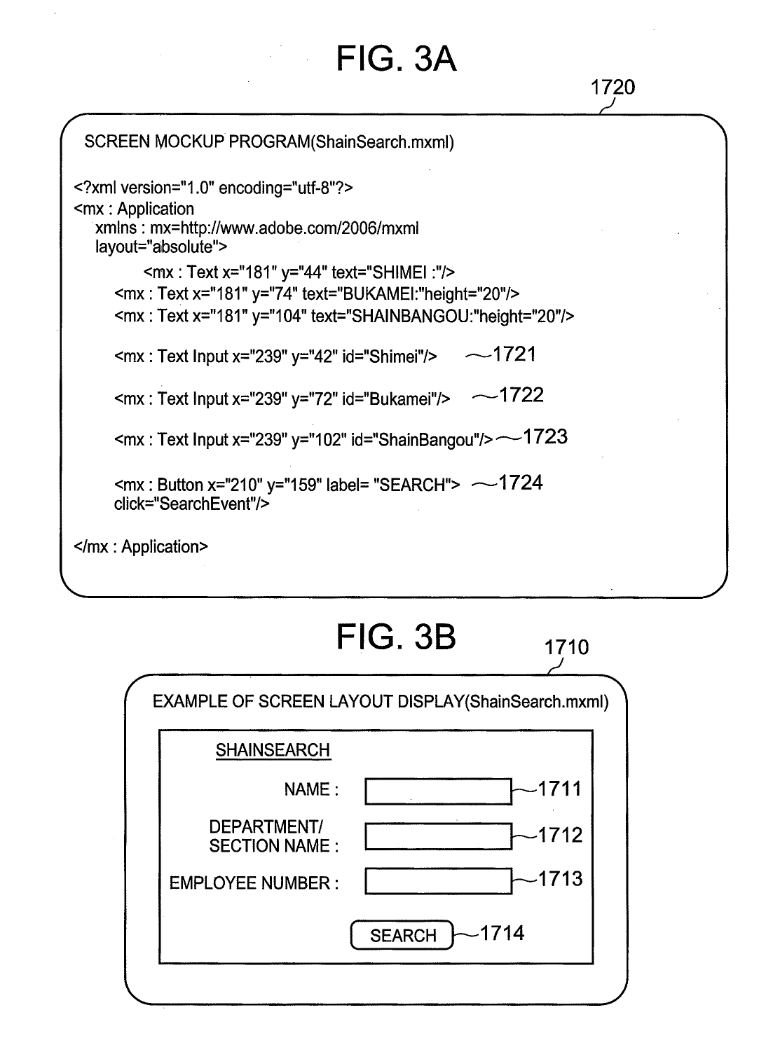

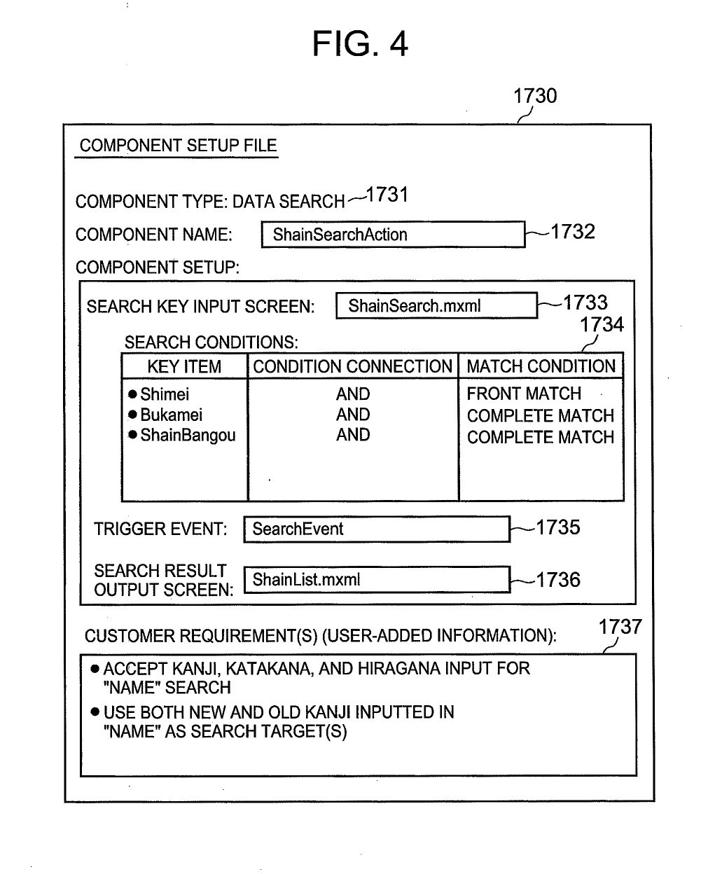

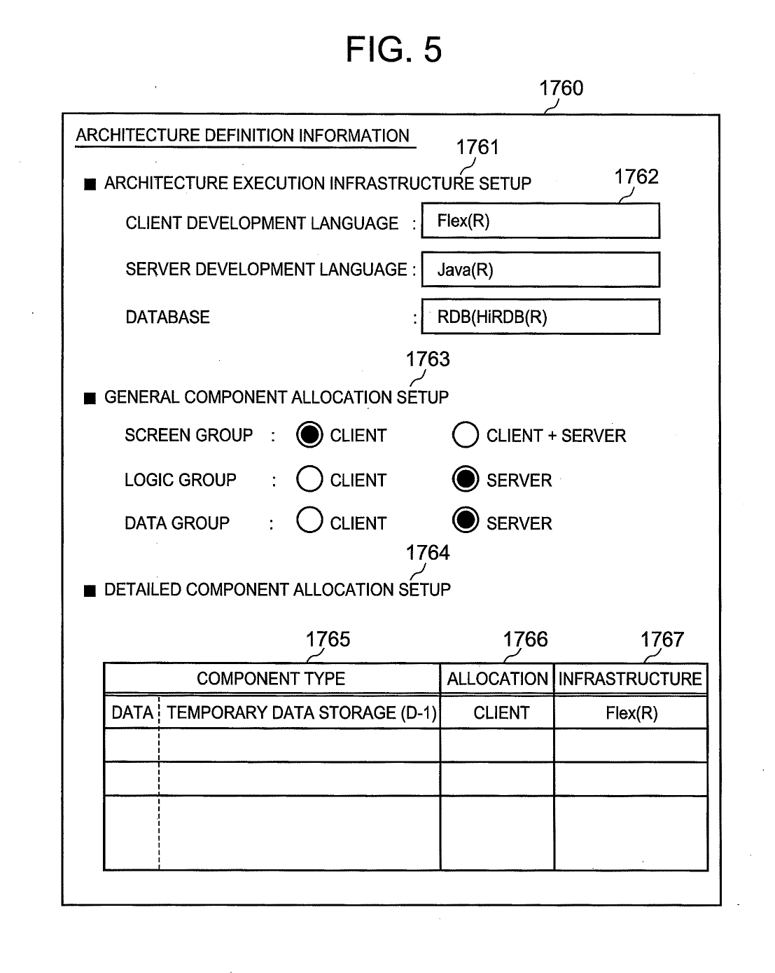

Input screen mockup data is stored in the input screen mockup storage part 170. In the embodiment, the input screen mockup data comprises a screen mockup program 1720 (refer to FIG. 3), a component setup file 1730 (refer to FIG. 4), and execution architecture definition information 1760 (refer to FIG. 5). This input screen mockup data is inputted via the input device 106 or the communication device 108, and written to the input screen mockup storage part 170 by the mockup design information analysis part 110.

FIG. 3 is an illustration of the screen mockup program 1720. The screen mockup program 1720 is a source program, which primarily describes a software GUI (Graphical User Interface), and is described in accordance with a fixed rule, such as defining a naming convention or a specific attribute so as to enable analysis by the mockup design information analysis part 110 of the present invention. The example of FIG. 3 is a screen mockup program in accordance with Flex (R). FIG. 3A is the script of the screen mockup program 1720. FIG. 3B shows an example of a mockup screen 1710, which is displayed as a result of executing the screen mockup program 1720. Character string input fields 1711, 1712, and 1713 are respectively defined using elements 1721, 1722, and 1723, and to show that dynamic data is being handled, respective data names (Shimei, Bukamei, ShainBangou) are inputted with respect to id attributes. A button 1714 is defined by an element 1724, and a trigger name (SearchEvent) is inputted with respect to a click attribute to show what operation occurs when the button is clicked.

FIG. 4 is an illustration of the component setup file 1730. The component setup file 1730 is the file, which describes a setup related to a component invoked from the mockup screen denoted by the screen mockup program 1720. For example, the component setup file 1730 comprises a component type 1731, a component name 1732 as attribute data for configuring a component, a search key input screen 1733, a search condition 1734, a trigger event 1735, and a search result output screen 1736, and a customer requirement 1737 related to a customer-desired matter, which cannot be realized with the component. In the example of the drawing, the setup of a component for operating in accordance with a SearchEvent, which is the trigger event of the screen mockup program 1720 shown in FIG. 3, is described.

FIG. 5 is an illustration of the execution architecture definition information 1760. The execution architecture definition information 1760 specifies an execution architecture in a production system. As used here, architecture includes physical and logical architectures, and, for example, includes what the configuration of a physical computer machine should be (for example, a standalone or client server configuration), and the configurations of the execution infrastructure of each machine and the components, which operate on these execution infrastructures.

The execution architecture definition information 1760, as shown in the drawing, comprises an architecture execution infrastructure setup 1761, a general component allocation setup 1763, and a detailed component allocation setup 1764.

The architecture execution infrastructure setup 1761 defines a program execution infrastructure in a software architecture. In the example of the drawing, Flex (R) is configured as a client development language 1762, Java (registered trademark) (R) is configured as a server development language, and HiRDB (R), which is a RDB (Relational DataBase) product, is configured as a database. Based on the object of the present invention, i.e. to transition a mockup without any modification to real product development, the client development language 1762 is the same language as the screen mockup development language, and as such, there is no need for a definition from the developer.

The general component allocation setup 1763 defines where in the architecture a program is to be allocated in units of component groups. In the example of the drawing, the screen group is configured so as to be allocated to a client, and the logic group and data group are configured so as to be allocated to servers.

The detailed component allocation setup 1764 describes in detail an exception to the definition of the architecture execution infrastructure setup 1761 and the general component allocation setup 1763. A component type 1765, a component allocation 1766, and a component execution infrastructure 1767 are configured in the detailed component allocation setup 1764. In the example of the drawing, the detailed component allocation setup 1764 is configured such that a temporary data storage component of the data group is allocated to a client, and the execution infrastructure is Flex (R).

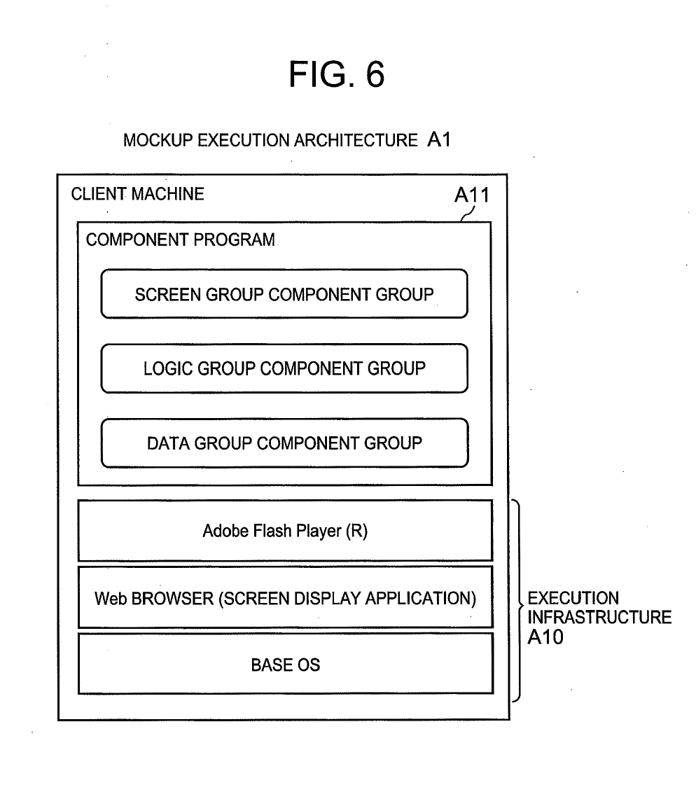

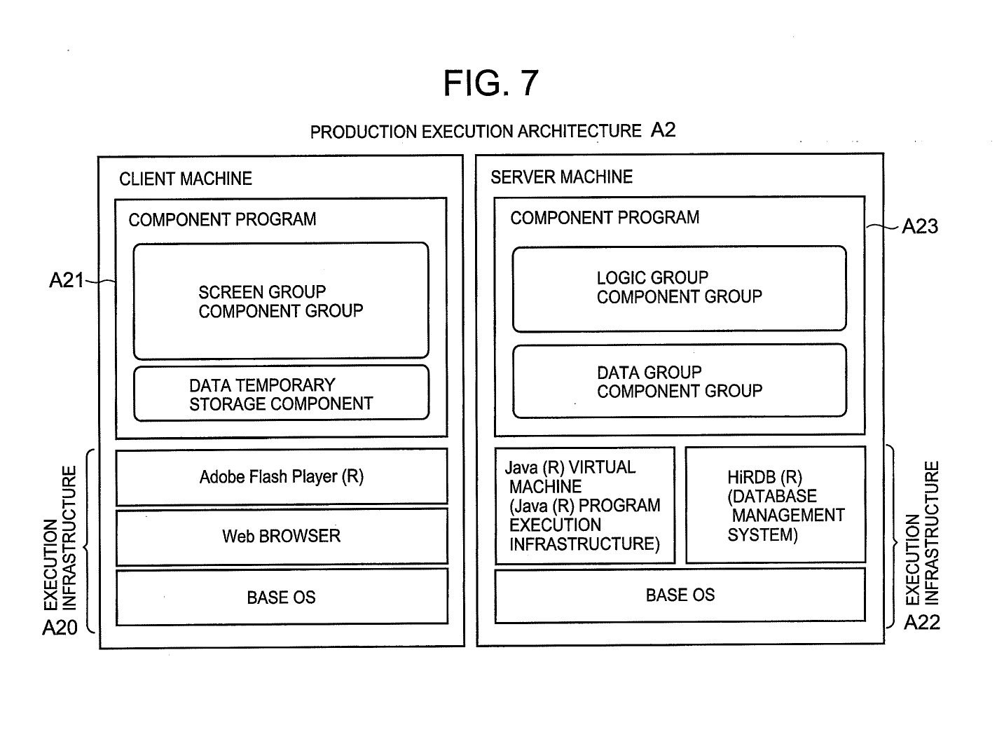

FIG. 6 shows a mockup execution architecture A1, which is the architecture for executing a mockup, and FIG. 7 shows a production execution architecture A2, which is the architecture for executing a production system. The mockup execution architecture A1 of FIG. 6 is a standalone configuration, and is the architecture in which a component program A11 of a screen group, a logic group, and a data group operates on an execution infrastructure A10 comprising a base OS, a Web browser, and Adobe Flash Player (R). The production execution architecture A2 of FIG. 7 corresponds to the execution architecture definition information 1760 of FIG. 5. That is, the production execution architecture A2 of the drawing is a client-server configuration, and on the client, a component program A21 of a screen group and a temporary data storage group operates on an execution infrastructure A20 comprising a base OS, a Web browser, and Adobe Flash Player (R), and on the server, a component program A23 of a logic group and a data group operates on an execution infrastructure A22 comprising a Java (R) virtual machine and a HiRDB (R).

Returning to FIG. 2, the result of the mockup design information analysis part 110 analysis of input screen mockup data stored in the input screen mockup storage part 170 is stored in the input mockup design information storage part 150. The input mockup design information storage part 150 comprises a screen mockup extraction information storage part 151, a mockup configuration component information storage part 152, a user-appended information storage part 153, and an architecture information storage part 154. The data stored in the input mockup design information storage part 150 will be explained in detail further below together with the processing of the mockup design information analysis part 110.

Component data comprising the specifications of components of multiple component types defined beforehand by architecture is stored in the by-architecture component list storage part 160. For example, a component list 1610, a component setup attribute definition 1620, a component code fragment group by architecture 1630, and a code fragment for interface generation 1640 are stored in the by-architecture component list storage part 160.

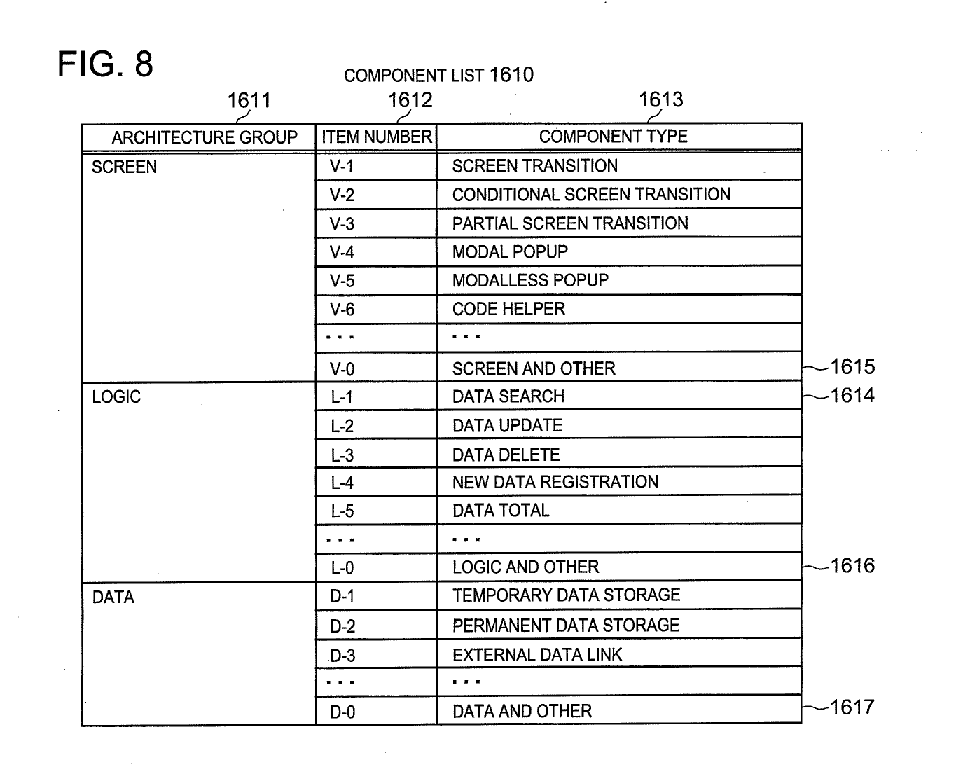

FIG. 8 shows an example of the component list 1610 showing a list of components capable of being used in the system. The component list 1610, for example, comprises an architecture group 1611, an item number 1612, and a component type 1613 as data items as shown in the drawing.

The architecture group 1611 is a group of architectures to which the respective components belong, and in the embodiment, there are “screen”, “logic” and “data”. This corresponds to the component program group described hereinabove.

The item number 1612 is identification information of a component related to the component type 1613.

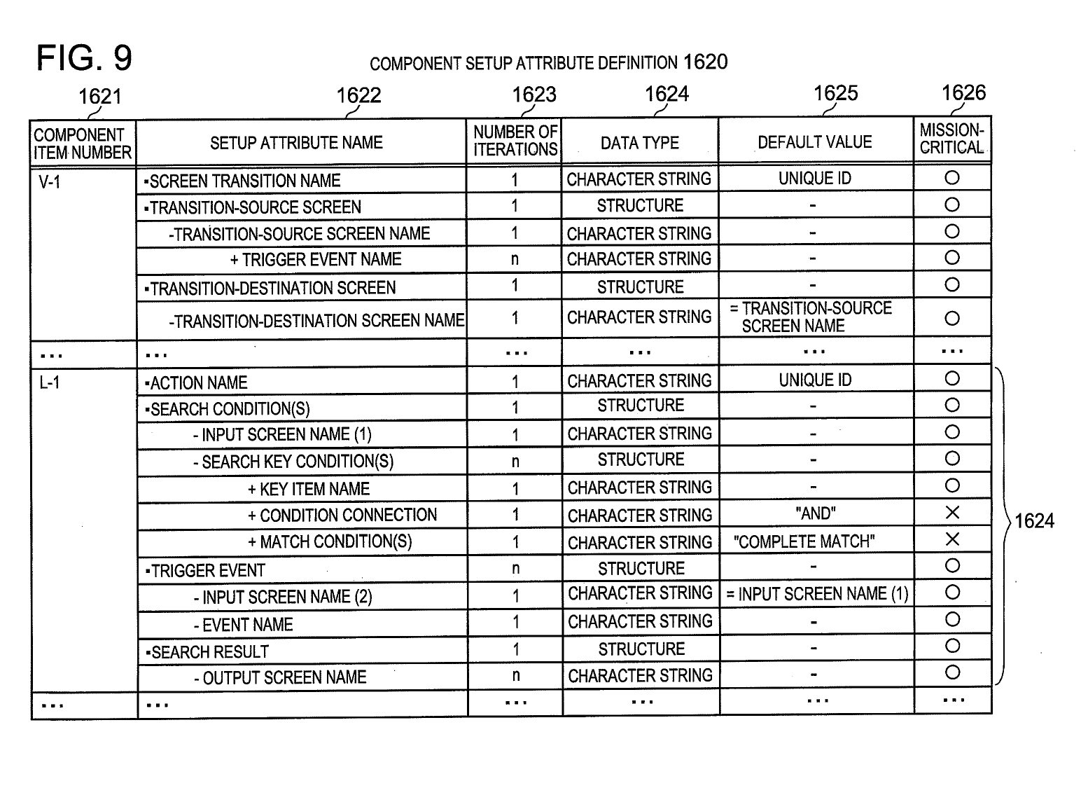

FIG. 9 shows an example of the component setup attribute definition 1620 comprising definition information of each component. The component setup attribute definition 1620 shows the specifications of a component. For example, the component setup attribute definition 1620 comprises a component item number 1621, a setup attribute name 1622, a number of iterations 1623, a data type 1624, a default value 1625, and a mission-critical flag 1626 denoting whether or not an item is essential.

The setup attribute name 1622 denotes an attribute item of each component. The setup attribute name 1622 may also comprise a hierarchical relationship with another item as with “transition-source screen” in the drawing.

The number of iterations 1623 denotes the number of iterations of an attribute item shown in the setup attribute name 1622 for an item of a higher-level hierarchy. For example, “trigger event name” in the drawing can be defined in times with respect to the “transition-source screen name”.

The default value 1625 is configured when a value has not been configured by the user. Configuring the default value 1625 as “unique ID” signifies that the system allocates an arbitrary unique ID to the item. A case in which a setup attribute name is linked to an equal sign (for example, “=transition-source screen name”) signifies that the default value 1625 assigns the same value as the setup attribute name (transition-source screen name). In addition, a case in which the default value 1625 is a character string enclosed by double quotation marks (for example, “AND”) signifies that the value in quotations itself is assigned.

The mission-critical flag 1626 denotes whether or not the setup attribute name 1622 is an essential item.

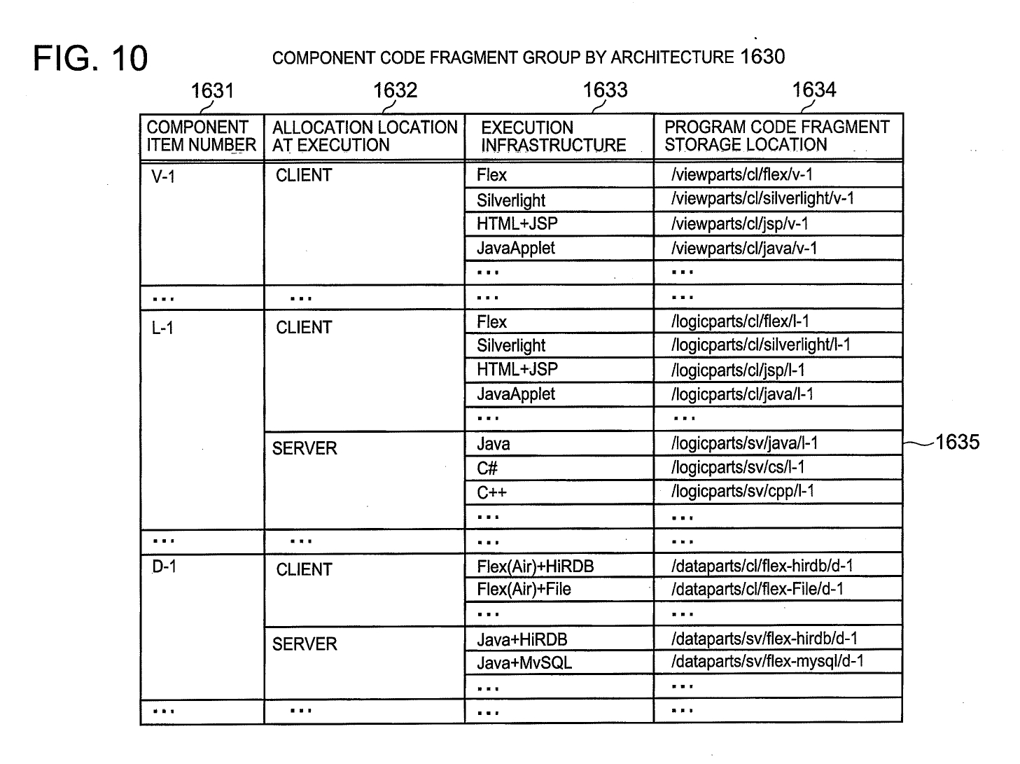

FIG. 10 shows an example of a component code fragment group by architecture 1630. The component code fragment group by architecture 1630 comprises both mockup execution architecture components and production execution architecture components. The component code fragment group by architecture 1630 comprises program code fragments by program execution infrastructure. The component code fragment group by architecture 1630 stores information denoting the environment at execution time for each component. For example, the component code fragment group by architecture 1630 comprises a component item number 1631, an allocation location at execution 1632, an execution infrastructure 1633, and a program code fragment storage location 1634 as data items. That is, the component code fragment group by architecture 1630 shows that a component code fragment, which a component of the component item number 1631 operates on either a server denoted in the allocation location at execution 1632 or an execution infrastructure denoted in the client execution infrastructure 1633, is stored in the program code fragment storage location 1634.

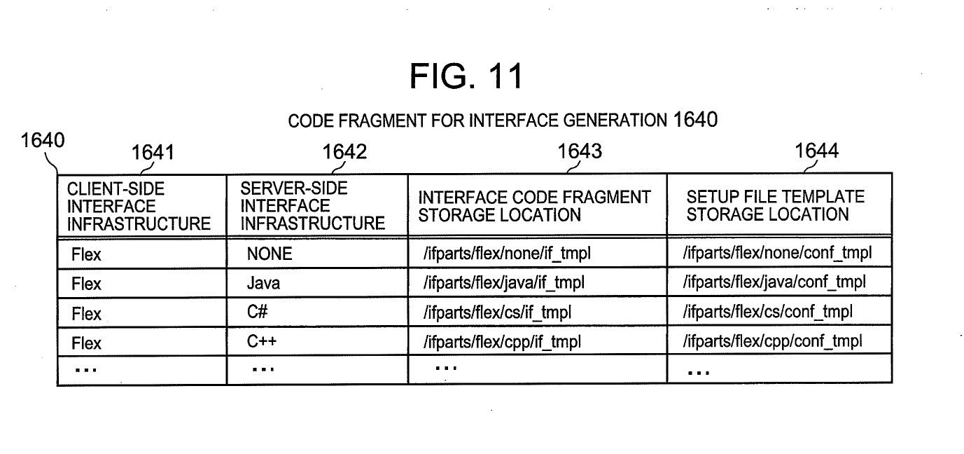

FIG. 11 shows an example of the code fragment for interface generation 1640. A code fragment necessary for an interface between components is defined in the code fragment for interface generation 1640. For example, in the example of FIG. 11, when the execution infrastructures of a client and a server are the client-side interface infrastructure 1641 and the server-side interface infrastructure 1642, respectively, this indicates that both an interface code fragment and a setup file template are stored in the locations denoted by an interface code fragment storage location 1643 and a setup file template storage location 1644.

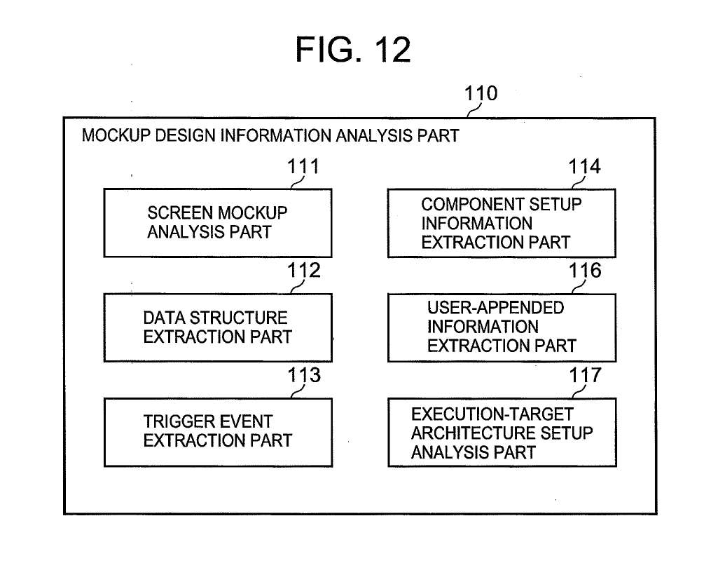

Next, FIG. 12 is a detailed functional block diagram of the mockup design information analysis part 110. That is, the mockup design information analysis part 110, as shown in the drawing, comprises a screen mockup analysis part 111, a data structure extraction part 112, a trigger event extraction part 113, a component setup information extraction part 114, a user-appended information extraction part 116, and an execution-target architecture setup analysis part 117.

The screen mockup analysis part 111 reads the screen mockup program 1720 from the input screen mockup storage part 170, and identifies a screen mockup development language from characteristic information, such as program file extension or a file header.

The screen mockup analysis part 111 determines whether or not an inputted screen mockup development language can be supported by the system while referencing the component code fragment group by architecture 1630 (refer to FIG. 10). For example, the screen mockup analysis part 111 determines whether or not the development language can be supported by the system in accordance with whether or not the programming language of the screen mockup program 1720 identified here exists in the execution infrastructure 1633 of a screen component (a component for which the component item number 1631 begins with “V”, and the allocation location at execution 1632 is “client”). For example, the development language of the screen mockup program 1720 of FIG. 3 is “Flex (R)”. Therefore, since a component for which the component item number 1631 begins with “V”, the allocation location at execution 1632 is “client”, and the execution infrastructure 1633 is “Flex (R)” exists in the component code fragment group by architecture 1630, the screen mockup analysis part 111 determines that the screen mockup program 1720 is executable.

In the embodiment, a determination as to executability is made using the component code fragment group by architecture 1630, but different information related to the execution infrastructure may be prepared beforehand, and executability may be compared with this information.

When analyzing a program, the screen mockup analysis part 111 makes use of the data structure extraction part 112 and the trigger event extraction part 113, which will be explained next. Information denoting the result of the analysis of the screen mockup analysis part 111 is stored in the screen mockup extraction information storage part 151.

The data structure extraction part 112 extracts a description related to a data structure from the screen mockup program 1720. The data structure here, for example, comprises a data input item and output item disposed inside a mockup screen. The data structure extraction part 112, for example, detects a specific attribute of the programming language, which denotes a structure, and extracts the element defining this structure. For example, in the screen mockup program 1720 of FIG. 3, first “ShainSearch”, which is the program filename, is extracted as the highest level data structure. In addition, of the elements defined in the file, the elements 1721, 1722, and 1723 for which names are described in the “id” attribute are extracted as dynamic data included in the ShainSearch structure. The data structure extraction part 112 extracts dynamic data for which a data name defined in accordance with a fixed rule has been assigned in the screen mockup program 1720.

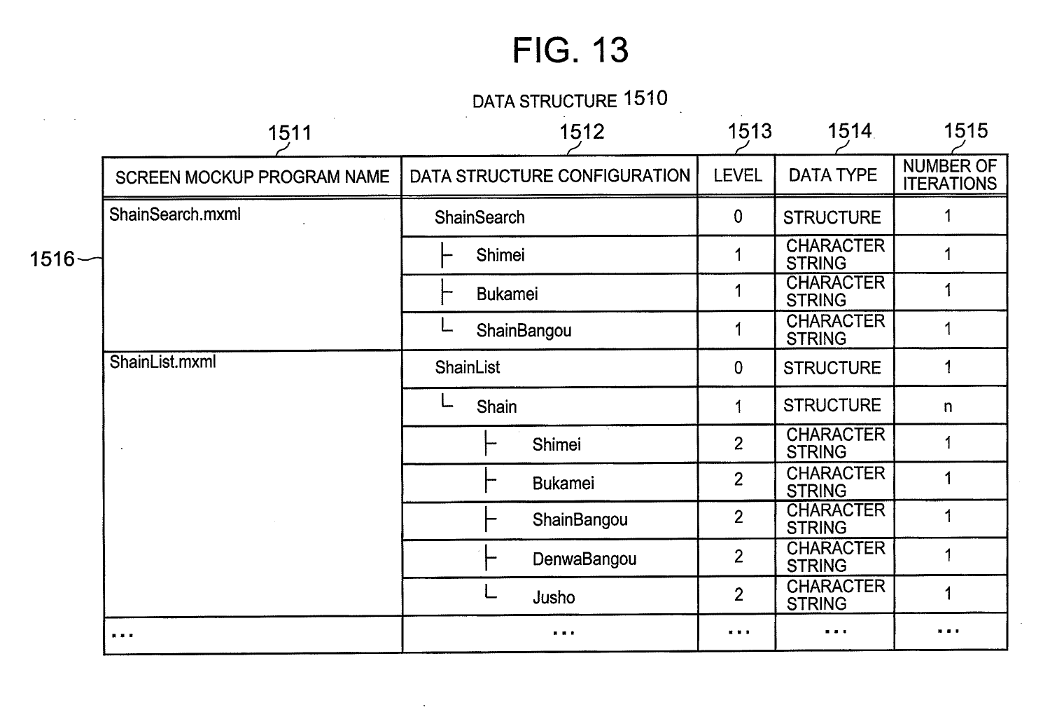

FIG. 13 shows an example of a data structure 1510 extracted by the data structure extraction part 112. The data structure 1510 comprises a screen mockup program name 1511, a data structure configuration 1512, a level 1513, which denotes the depth on a hierarchy, a data type 1514, and a number of iterations 1515 as data items.

Returning to FIG. 12, the trigger event extraction part 113 extracts a description related to a trigger event from the screen mockup program 1720. The trigger event, for example, is a button in the mockup screen for receiving an event input from the user. The trigger event extraction part 113, for example, searches for an event generation definition provided by the framework of the screen mockup program 1720. For example, in the case of Flex (R), it is an event such as “click” or “keyDown”. In the case of the screen mockup program 1720 of FIG. 3, the trigger event extraction part 113 extracts the element 1724 as the trigger event.

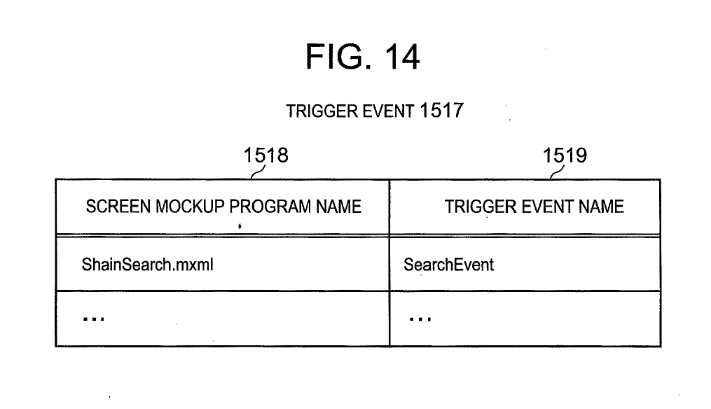

FIG. 14 shows an example of a trigger event 1517 extracted by the trigger event extraction part 113. The trigger event 1517 comprises a screen mockup program name 1518 and a trigger event name 1519 as data items.

Returning to FIG. 12, the component setup information extraction part 114 generates component design information (configuration component setup information) to be invoked from the screen mockup program 1720 by referencing the by-architecture component list storage part 160 and the input screen mockup storage part 170.

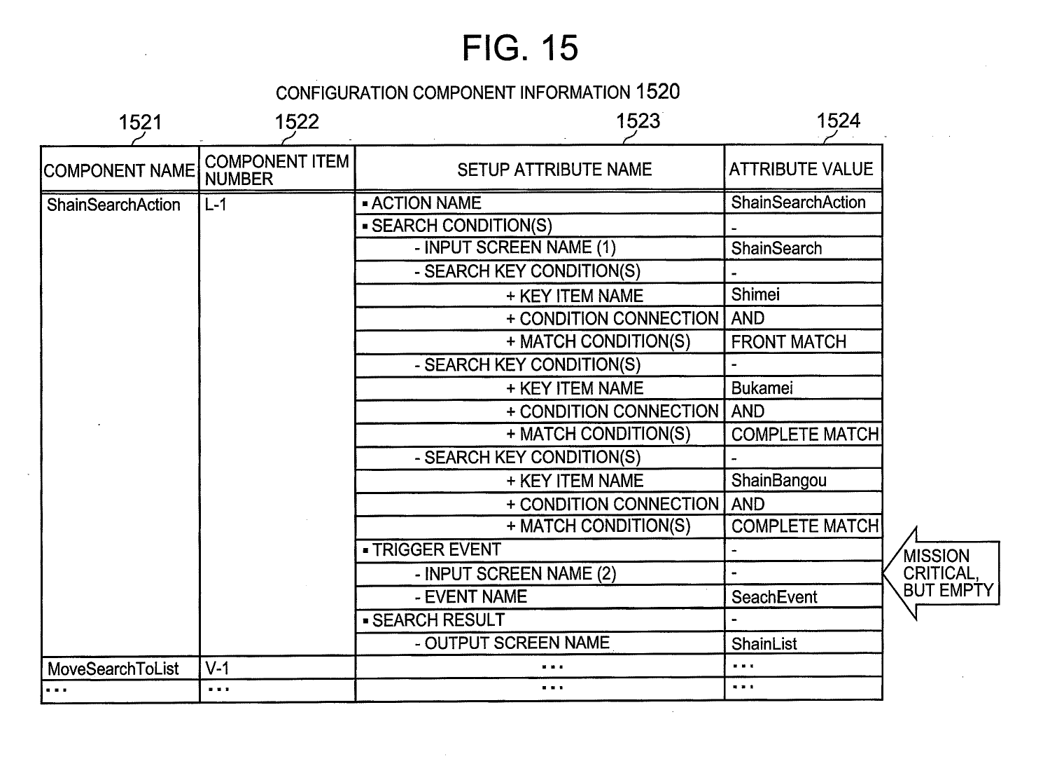

FIG. 15 shows an example of configuration component setup information 1520, which is component design information generated by the component setup information extraction part 114. The configuration component setup information 1520 comprises a component name 1521, a component type 1522, a setup attribute name 1523, and an attribute value 1524 as data items.

For example, the component setup information extraction part 114 identifies an item number 1612, which is allocated to a component type 1731 of the component setup file 1730, by referencing the component list 1610 (refer to FIG. 8). Next, the component setup information extraction part 114 acquires from the component setup attribute definition 1620 (refer to FIG. 9) the setup attribute name 1622 of the component of the item number 1612 (1621) identified here. The component setup information extraction part 114 stores the information acquired here with respect to each corresponding item of the configuration component setup information 1520. In addition, the component setup information extraction part 114 acquires the attribute data 1732 through 1736 of the component defined in the component setup file 1730, and stores this attribute data in the attribute value 1524 of each corresponding setup attribute name 1523 of the configuration component setup information 1520. When the attribute data corresponding to the component setup file 1730 is not configured at this point, the attribute value 1524 is left blank. The component setup information extraction part 114 extracts the information described in the customer requirement 1737, and stores this information in the user-appended information storage part 153.

The component setup information extraction part 114 and the user-appended information extraction part 116 extract from the input screen mockup data a description related to a function, which cannot be realized by any of multiple component types stored in the by-architecture component list storage part 160.

For example, the component setup information extraction part 114, in a case where a component type 1731 of the component setup file 1730 is not registered in the component list 1610 (Refer to FIG. 8) and corresponds to “other” in “screen and other” and so forth, configures a component type 1522 in the item numbers (V-0, L-0, D-0) corresponding to the “other” of each corresponding architecture group 1611. The setup attribute name 1523 and the attribute value 1524 of a component for which the component type 1522 has been classified as “other” are blank. Therefore, this component is not targeted when the system automatically generates a program code. All of the information configured in the attributes 1732 through 1736 and the customer requirement 1737 of the component for which the component type 1522 has been classified as “other” is stored in the user-appended information storage part 153.

The user-appended information extraction part 116 extracts a program code and a comment, which the user uniquely defined by exceeding a range prepared beforehand using components, from the screen mockup program 1720 and the execution architecture definition information 1760 of the input screen mockup storage part 170, and writes the program code and comment to the user-appended information storage part 153. As used here, the uniquely defined program code is a program code appended to a component for realizing a detailed expression or the like, which could not be supported with system-generated parts. The user-appended information extraction part 116 may perform extraction by detecting a difference with a component-determined extension and a generation code. The user-appended information, for example, need not directly define a component action, but rather may use text to describe the user's wishes for real product development.

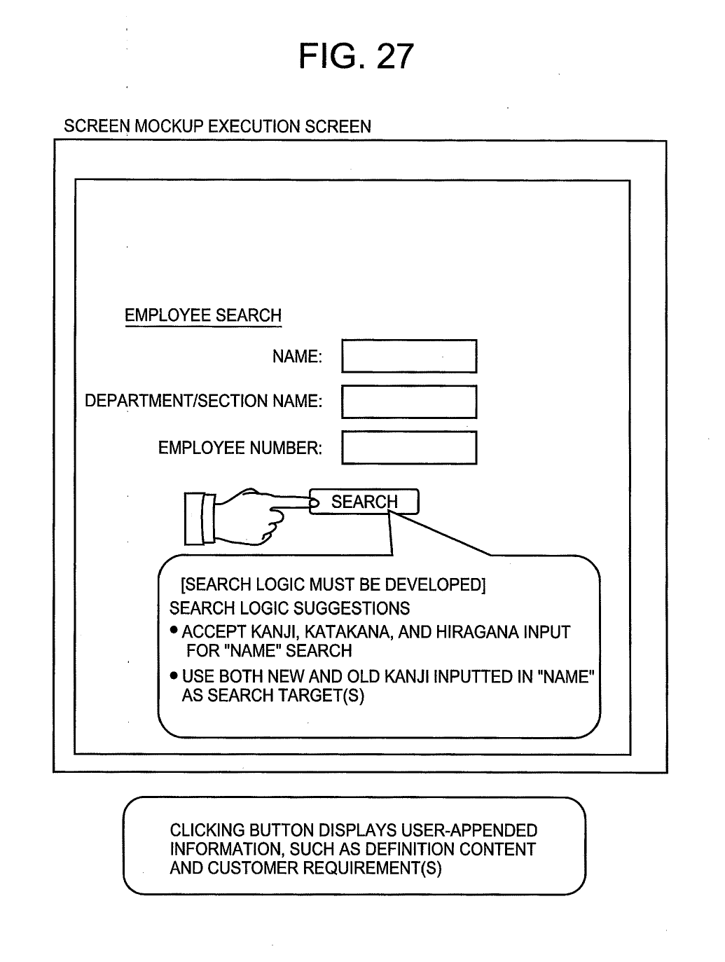

Information stored in the user-appended information storage part 153 may be outputable using a variety of methods. For example, the program code generation part 140, which will be explained further below, may be included as a comment in a program code, which executes a display of what will be implemented subsequently using either a skeleton code, which does not operate anything at all, or a popup or the like at component invocation. For example, FIG. 27 shows an example of outputting information stored in the user-appended information storage part 153 in a popup displayed at component invocation. The information stored in the user-appended information storage part 153 may also be outputted as either an issue management sheet or a specification for real product development. This makes it possible to reduce omissions in dealing with customer requirements.

Returning to FIG. 12, the execution-target architecture setup analysis part 117, on the basis of the execution architecture definition information 1760, generates execution architecture setup information 1540 denoting a program execution infrastructure corresponding to the execution architecture specified in the execution architecture definition information 1760. The execution architecture setup information 1540 is stored in the architecture information storage part 154. In other words, the execution-target architecture setup analysis part 117 generates execution architecture setup information 1540 for the production execution architecture.

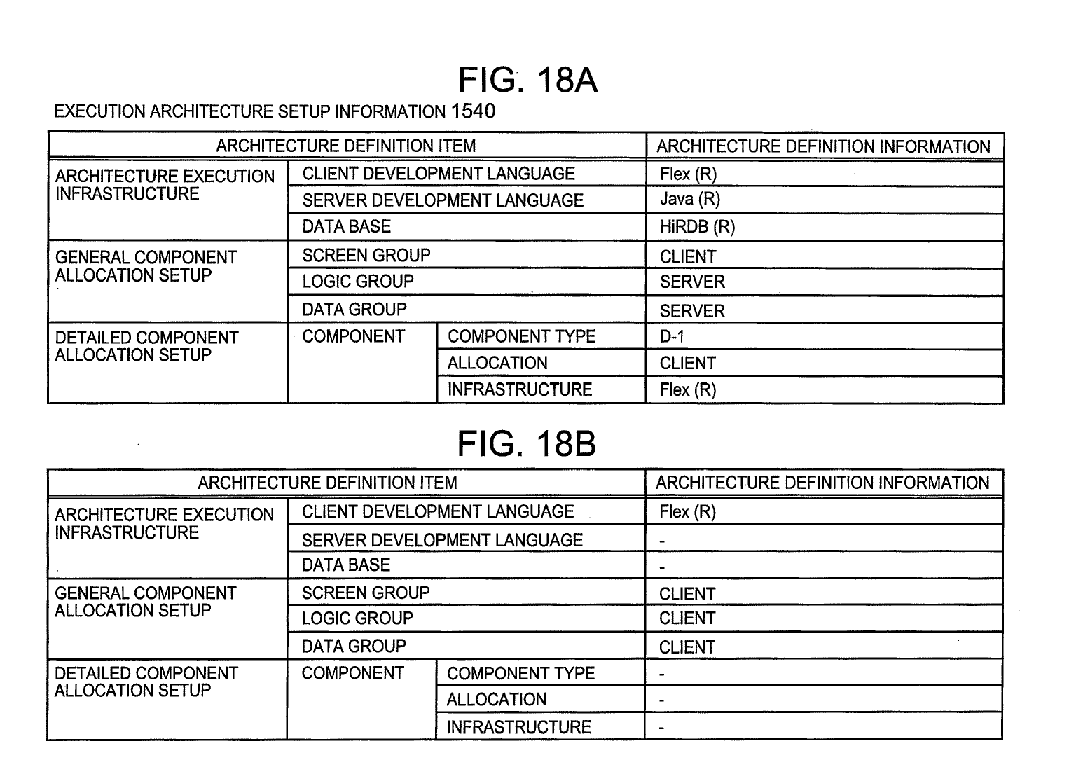

FIG. 18 shows an example of the execution architecture setup information 1540. The execution architecture setup information 1540 comprises an architecture definition item 1541 and an attribute value 1542 as shown in the drawing. FIG. 18A is generated from the execution architecture definition information 1760.

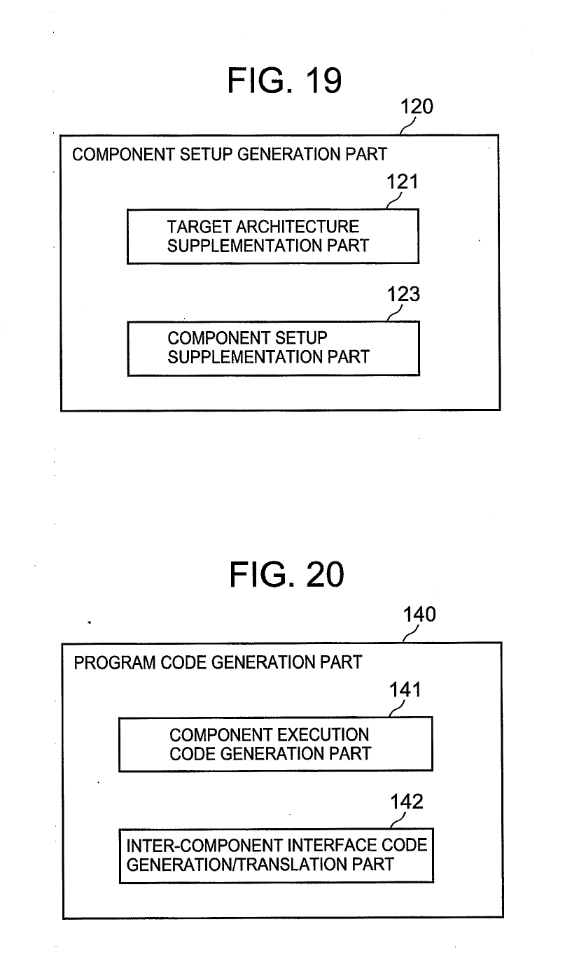

FIG. 19 is a functional block diagram of the component setup generation part 120 realized when the component setup generation program 120P is executed by the CPU 101. That is, the component setup generation part 120 comprises a target architecture supplementation part 121 and a component setup supplementation part 123.

When the execution architecture definition information 1760 does not exist, the target architecture supplementation part 121 references the screen mockup program 1720 and generates execution architecture setup information 1540, which assumes a mockup execution architecture for executing all the components on the client. That is, in a case where the developer does not specify the execution architecture definition information 1760, the system generates a program code using a prototyping architecture for a mockup. An example of the execution architecture setup information 1540 generated when the execution architecture definition information 1760 does not exist is shown in FIG. 18B. The programming language at this time may be the same as that of the screen mockup program 1720.

The component setup supplementation part 123 performs supplementation processing with respect to the results of analysis of input screen mockup data. For example, first, the component setup supplementation part 123 verifies the extraction results of the screen mockup analysis part 111 through the component setup information extraction part 114. For example, the component setup supplementation part 123 may verify the following points by referencing the data structure 1510, the trigger event 1517, and the configuration component setup information 1520, as well as the component setup attribute definition 1620.

(1) Are the data type 1514 and the number of iterations 1515 of the data structure 1510 appropriate?
(2) The correctness of the definition, such as the presence or absence in the configuration component setup information 1520 of an item for which a value has not been defined even though it is a mission-critical item.
(3) Are there any discrepancies between the component setup attribute definition 1620 and the already extracted data structure 1510 and trigger event 1517?

For example, the component setup supplementation part 123 carries out a prescribed supplementation process for a required location based on the results of the verification. For example, the component setup supplementation part 123 determines in accordance with the mission-critical flag 1626 of the component setup attribute definition 1620 whether or not a setup attribute name 1523 for which an attribute value 1524 has not been configured is a mission-critical item. Then, when it has been determined in accordance with the mission-critical flag 1626 that the setup attribute name 1523 is a mission-critical item, the component setup supplementation part 123 configures the corresponding default value 1625 in the attribute value 1524.

The component setup supplementation part 123, after performing the process for configuring the above-mentioned default value 1625 in the attribute value 1524, once again determines whether or not values have been configured in the configuration component setup information 1520 for all mission-critical items for which a mission-critical flag 1626 has been set in the component setup attribute definition 1620. When a value has not been configured in any mission-critical item, the component setup supplementation part 123 changes the component type 1522 of the component to “other”. This is because an executable program code cannot be generated for this component in a case where a mission-critical item has not been configured.

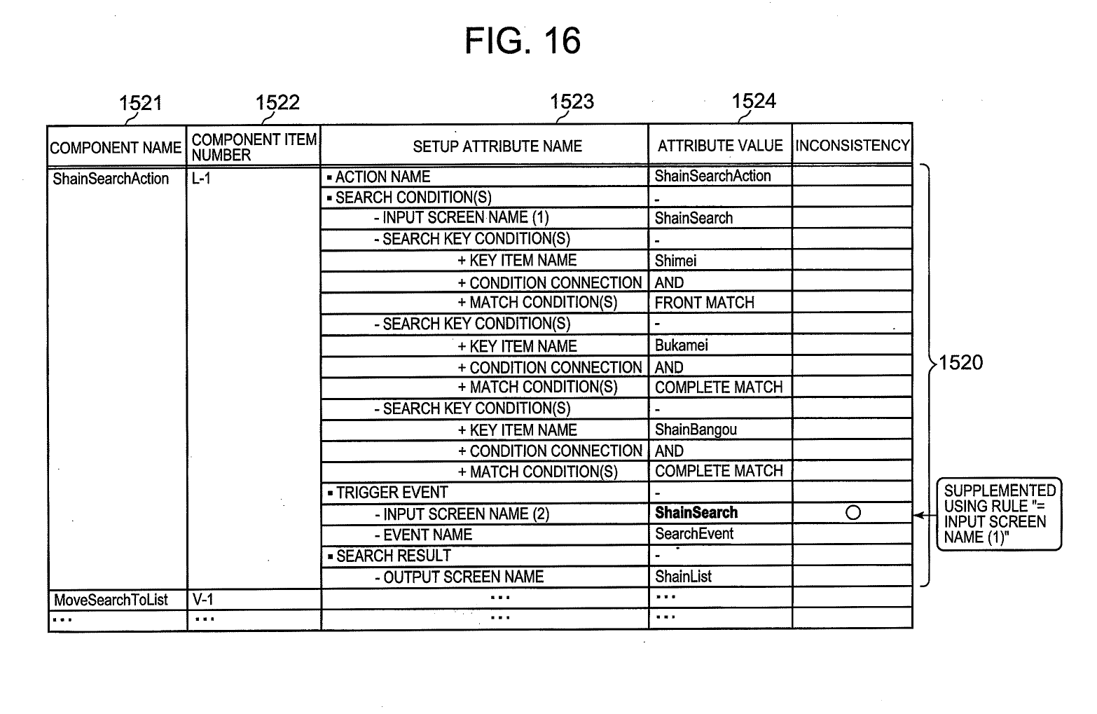

For example, an attribute value 1524 has not been configured for the “input screen name (2)” of the “trigger event” in the configuration component setup information 1520 of FIG. 15. Consequently, when the component setup supplementation part 123 supplements a default value in accordance with the rule “=input screen name (1)” defined in the component setup attribute definition 1620, the result is as shown in FIG. 16.

The component setup supplementation part 123 may also check for consistency in accordance with whether or not the search key input screen 1733 and the key item names (ShainSearch, Shimei, Bukamei, ShainBangou) of the search condition 1734 of the component setup file 1730 exist in the data structure configuration 1512 of the data structure 1510. Or, the component setup supplementation part 123 may check for consistency in accordance with whether or not the trigger event name 1735 (SearchEvent) of the component setup file 1730 matches the trigger event name 1519 of the trigger event 1517.

Referencing FIG. 2 once again, the component execution architecture decision part 130 selects on the basis of the component design information a program code fragment, which operates on a configured program execution infrastructure. The program code generation part 140 generates a program code by configuring attribute data in the selected program code fragment.

The component execution architecture decision part 130 identifies a program code fragment necessary for realizing an architecture defined in the execution architecture setup information 1540 by referencing the configuration component setup information 1520 and the by-architecture component code fragment list 1630. The component execution architecture decision part 130 adds the information identified here to the configuration component setup information 1520. A specific example of the processing performed by the component execution architecture decision part 130 will be explained hereinbelow.

First, the component execution architecture decision part 130 identifies a target component from the configuration component setup information 1520 (refer to FIGS. 15 and 16). For example, “ShainSearchAction” is targeted here. The component execution architecture decision part 130 uses the component type 1522 “L-1” of the target component “ShainSearchAction” as a key to identify the corresponding architecture group 1611 “logic group” from the component list 1610 (refer to FIG. 8). Next, the component execution architecture decision part 130 identifies the fact that the machine to which the “logic group” is allocated is the “server” from the “general component allocation setup” of the execution architecture setup information 1540 (refer to FIG. 18A). In addition, the component execution architecture decision part 130 identifies that the server development language is “Java (R)”.

Next, the component execution architecture decision part 130 uses three pieces of information as keys, i.e. the component item number “L-1”, the architecture definition information “server”, and the server development language “Java (R)” acquired in the above-mentioned processing, searches for the component item number 1631, the allocation location at execution 1632, and the execution infrastructure 1633 of the by-architecture component code fragment list 1630 (refer to FIG. 10), and acquires the corresponding program code fragment storage location 1634 “/logicparts/sv/java/1-1” from the relevant record 1635.

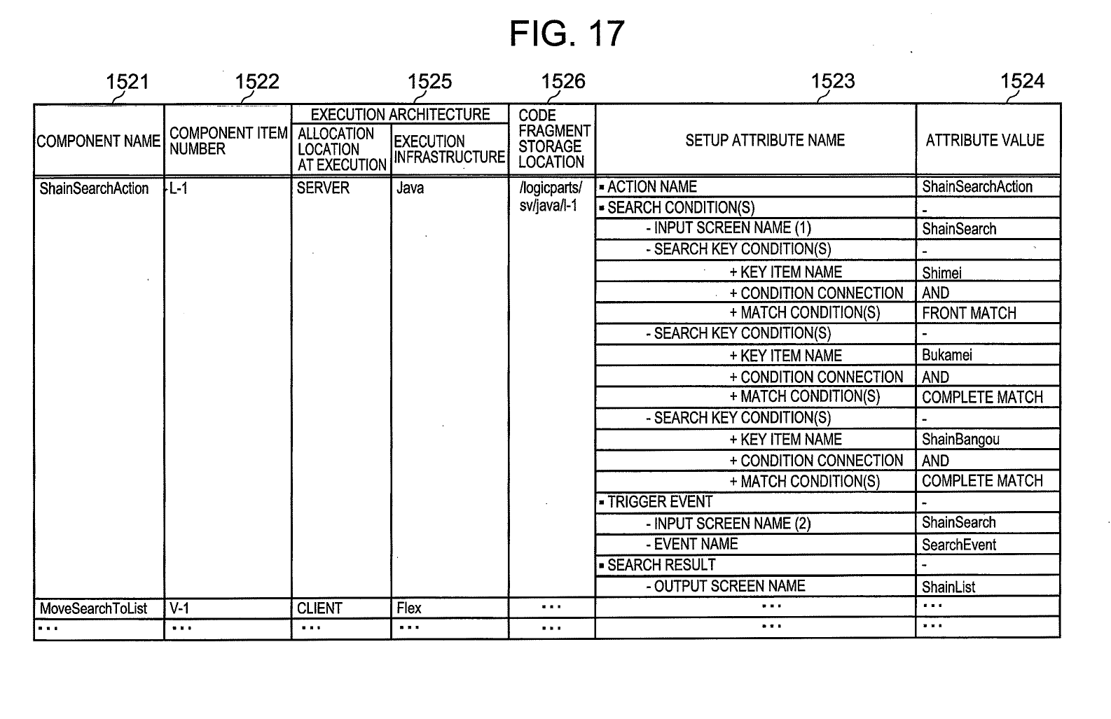

The component execution architecture decision part 130 adds the execution architecture 1525 and the code fragment storage location 1526 comprising the allocation location at execution and the execution infrastructure identified in accordance with the above-mentioned processing as items to the configuration component setup information 1520. An example of component setup information supplemented with the execution architecture 1525 as well as the code fragment storage location 1526 is shown in FIG. 17.

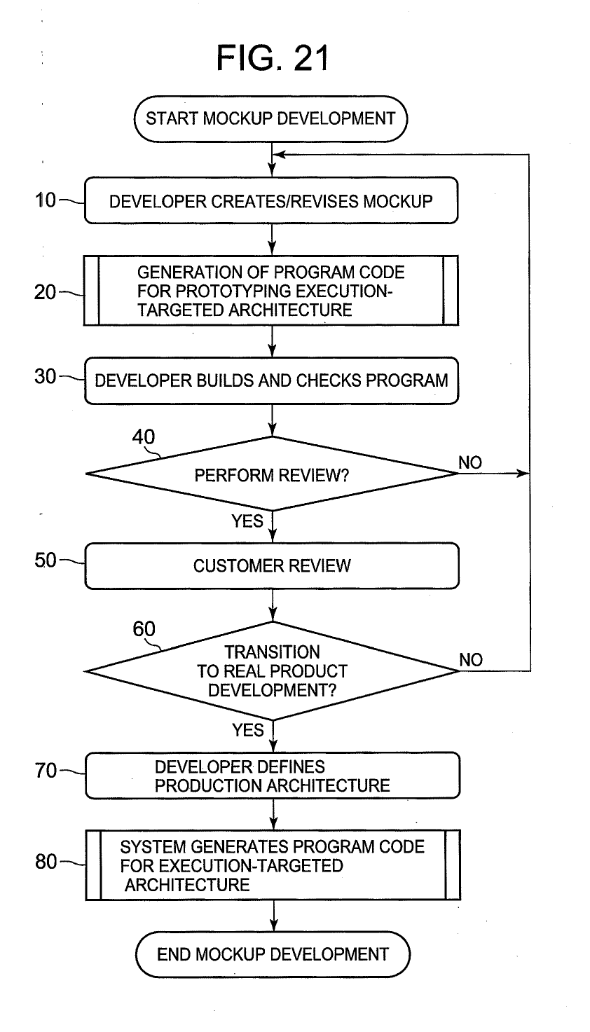

FIG. 20 is a functional block diagram of the program code generation part 140 realized when the program code generation program 140P is executed by the CPU 101. That is, the program code generation part 140 comprises a component execution code generation part 141 and an inter-component interface code generation/translation part 142.

The component execution code generation part 141 references the configuration component setup information 1520, acquires a program code fragment from the code fragment storage location 1526, and generates an execution program code corresponding to each component. For example, the component execution code generation part 141 acquires a program code fragment of each setup attribute name 1523 from the location stipulated in the code fragment storage location 1526 of the configuration component setup information 1520, embeds the value of the attribute value 1524 in the code fragment, and generates an execution program code for the relevant components while performing translation. The attribute value 1524 also comprises the default value 1625. In other words, the component execution code generation part 141 generates the execution program code by embedding the default value 1625 in the program code fragment.

The inter-component interface code generation/translation part 142 references the configuration component setup information 1520 and the code fragment for interface generation 1640, and generates an inter-component interface program code and an interface setup file. For example, the inter-component interface code generation/translation part 142 references the execution architecture 1525, identifies a combination of a server execution infrastructure and a client execution infrastructure, identifies the interface code fragment storage location 1643 and the setup file template storage location 1644 corresponding to the code fragment for interface generation 1640, and acquires an interface code fragment and a setup file template therefrom. The inter-component interface code generation/translation part 142 also generates an interface setup file by configuring an invocation method name and a data type determined by a component operated on the server execution infrastructure and a component operated on the client execution infrastructure in the template file acquired here. The inter-component interface code generation/translation part 142 also reads the screen mockup program 1720, and performs text translation for making a part, which is a special notation established for information extraction, compilable using the execution infrastructure.

The processing steps for when a process is performed by the mockup development support system 100, which comprises a configuration like that described hereinabove, will be explained.

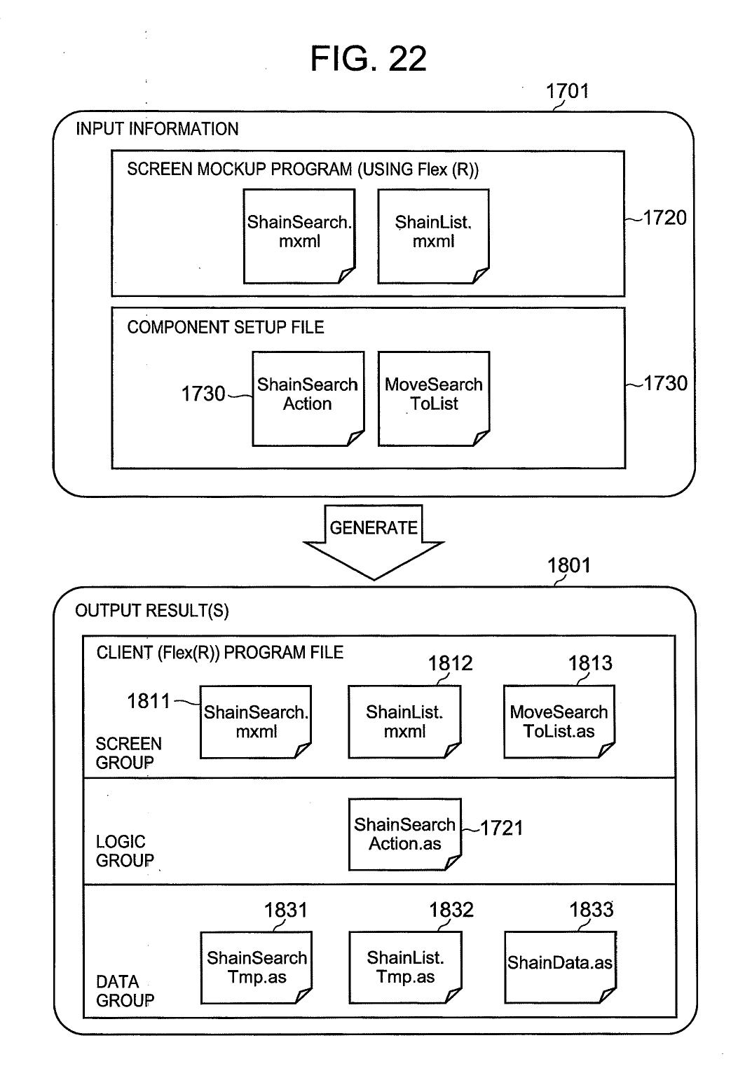

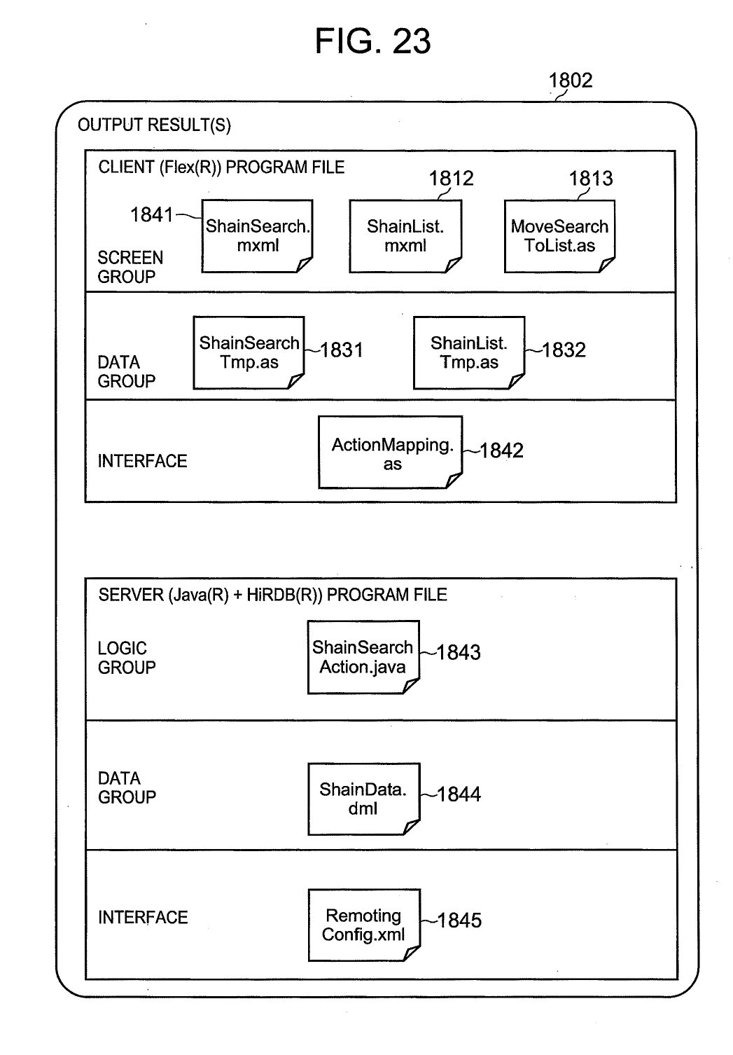

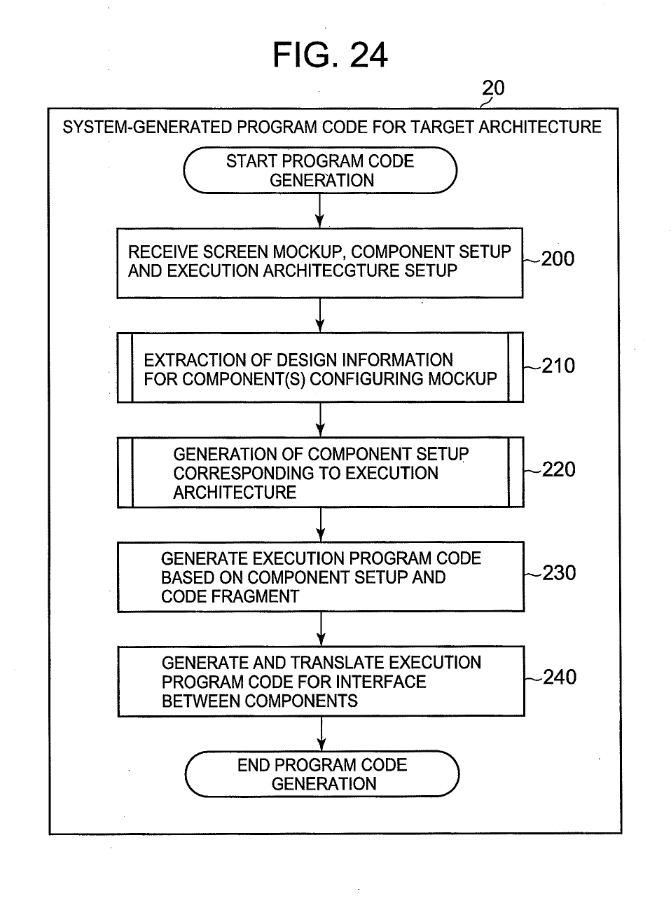

First, FIG. 21 is a flowchart showing the steps of an entire mockup development process using the system 100. FIG. 22 shows an example of an input/output file when generating a program code for a mockup execution architecture. FIG. 23 shows an example of an output file when generating a program code for a production execution architecture. Using FIGS. 21, 22 and 23, the explanation will focus mainly on input and output with respect to the system 100.

In Step 10, with prototyping as the objective, the developer either creates or revises a screen mockup using the mockup development environment 191. The screen mockup program 1720 (“ShainSearch.mxml” and “ShainList.mxml”) and the component setup file 1730 (“ShainSearchAction” and “MoveSearchToList”), which are shown as the input information 1701 in FIG. 22, are generated at this point.

The “ShainList.mxml” is a screen mockup program, which shows an image of a list of employees, and “MoveSearchToList” is a component setup file with a component type of “screen transition” for realizing a screen transition from a ShainSearch screen to a ShainList screen.

In Step 20, a program code for a mockup execution architecture is generated on the basis of the above-mentioned input information 1701. The reason a program code for a mockup execution architecture is generated instead of for a production execution architecture here is because the execution architecture definition information 1760 is not included in the input information 1701. The program code for a prototyping execution architecture generated in Step 20 is respective program files 1811 through 1833, which are shown as the output result 1801 in FIG. 22. The processing of Step 20 will be described in detail further below.

A “ShainSearch.mxml” 1811 and a “ShainList.mxml” 1812 are execution formatting programs derived by respectively translating the “ShainSearch.mxml” and the “ShainList.mxml” of the screen mockup program 1720. A “MoveSearchToList.as” 1813 is a screen transition program file generated on the basis of the “MoveSearchToList” of the component setup file 1730. A “ShainSearchAction.as” 1821 is a search program file generated on the basis of the “ShainSearchAction” of the component setup file 1730. A “ShainSearchTmp.as” 1831, a “ShainListTmp.as” 1832 and a “ShainData.as” 1833 are program files for storing data structures generated from the dynamic data information described in the screen mockup program 1720.

In Step 30, the developer uses the mockup development environment 191 to build and check the operation of the program generated in Step 20.

In Step 40, a determination is made as to whether or not to carry out a customer review based on the results of the operation check of Step 30. In a case where the determination is to carry out a customer review, the developer proceeds to Step 50, and in a case where the determination is not to carry out a review, the developer returns to Step 10.

In Step 50, the developer uses the mockup review environment 192 to carry out a customer review by operating the program generated in Step 20. Comments obtained from the customer at this time may be recorded in the screen mockup program, the component setup file, or the issue management sheet, and can be read later.

In Step 60, the developer determines whether or not to transition to real product development on the basis of the customer review results of Step 50. In a case where the determination is to transition to real product development, the developer proceeds to Step 70, and in a case where the determination is not to transition to real product development, the developer returns to Step 10.

In Step 70, the developer defines the production execution architecture definition information 1760 (refer to FIG. 5) for real product development.

In Step 80, a program code for the production execution architecture is generated. The detailed processing steps of Step 80 are the same as those of Step 20. The program code for the production execution architecture generated here is program files 1841 through 1845 shown as the output results 1802 in FIG. 23.

In addition to the respective programs 1812, 1813, 1831, and 1832 generated in Step 20, the following programs are included in the output results 1802. That is, the output results 1802 comprise executable format programs “ShainSearch.mxml” 1841 and “ShainSearchAction.java” 1843 derived by respectively translating the screen layout 1710 and the component setup file 1730, a program file “ShainData.dml” 1844 for defining a data structure definition extracted from the screen mockup program 1720 in a database, which exists in the server, and interface files “ActionMapping.as” 1842 and “RemotingConfig.xml” 1845 for executing a method invocation and so forth between different architectures.

Using the system 100 makes it possible to easily transition from the mockup program to real product development.

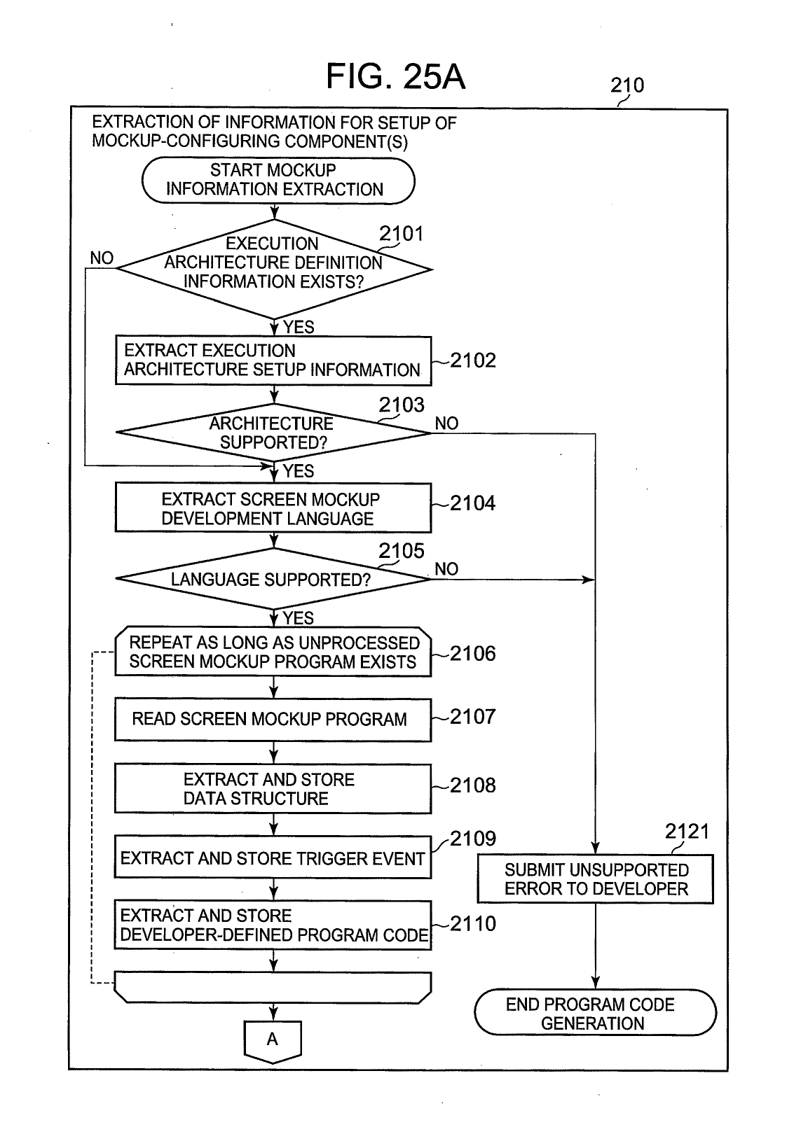

Next, the processing of Step 20 will be explained in detail on the basis of the flowcharts of FIGS. 24 through 26.

FIG. 24 is a flowchart showing the detailed steps of a program code generation process.

First, the mockup design information analysis part 110 receives the screen mockup program 1720, the component setup file 1730, and the execution architecture definition information screen 1760 inputted by the developer, and stores this input information in the input screen mockup storage part 170 (Step 200).

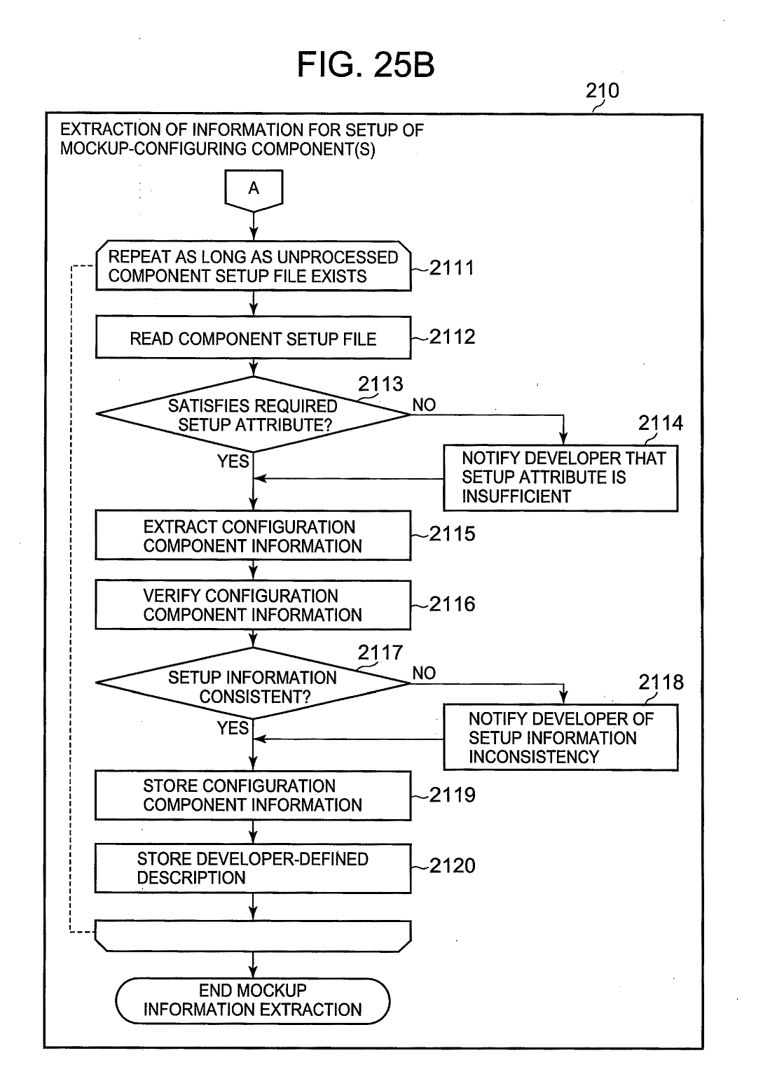

The mockup design information analysis part 110 extracts input mockup information for configuring a component, which comprises a mockup, from the information received in Step 200 (Step 210). The processing of Step 210 (shown in FIGS. 25A and 25B) will be explained in detail further below.

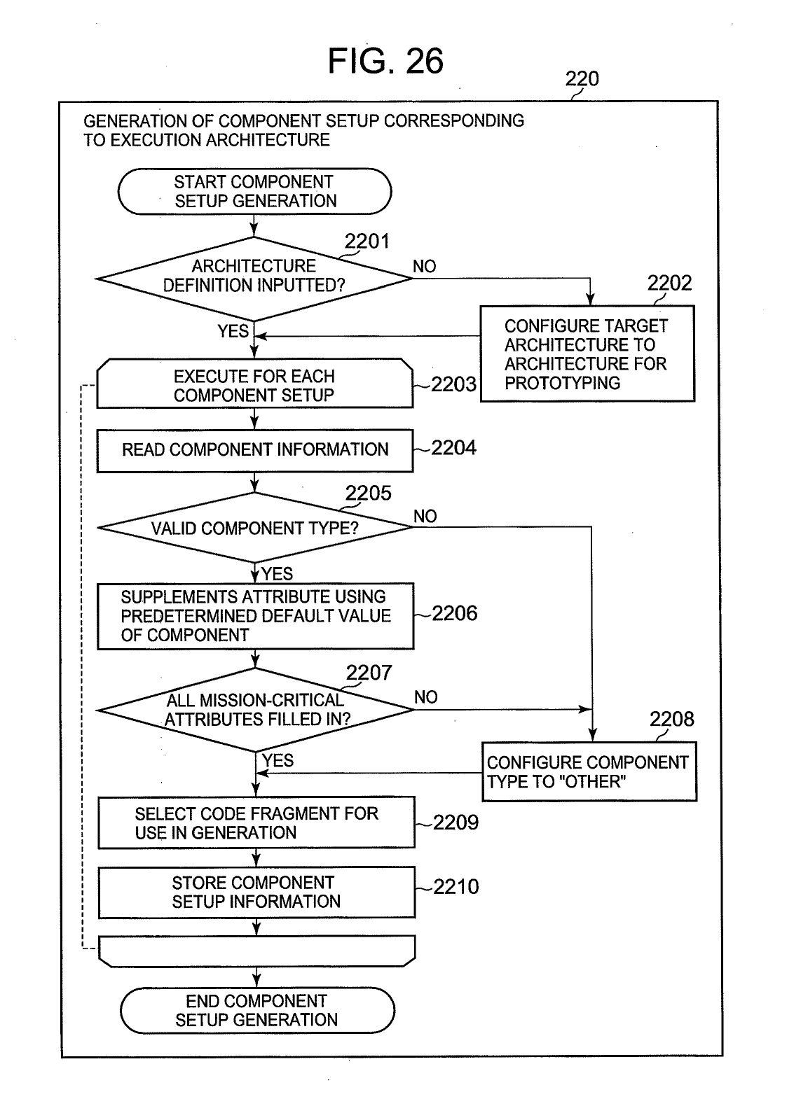

Next, the component setup generation part 120 generates a component setup according to an execution architecture for prototyping or real product development (Step 220). The processing of Step 220 (shown in FIG. 26) will be described in detail further below.

The component execution code generation part 141 generates an execution program code (Step 230). For example, the component execution code generation part 141 reads the configuration component setup information 1520 of the mockup configuration component information storage part 152. Then, the component execution code generation part 141 acquires by-program execution architecture component code fragments for generation use from the code fragment storage location 1526, which is recorded in the configuration component setup information 1520. In addition, the component execution code generation part 141 embeds the attribute value 1524 in the acquired code fragment, and generates an execution program code for the relevant component while performing translation.

The inter-component interface code generation/translation part 142 generates an inter-component interface code (Step 240). For example, the inter-component interface code generation/translation part 142 generates an interface code while referencing the code fragment for interface generation 1640 so as to enable mutual cooperation with respect to the execution program code of each component generated in Step 230. The inter-component interface code generation/translation part 142 reads the screen mockup program 1720 from the input screen mockup storage part 170, and performs text translation for making a part, which is a special notation established for information extraction, compilable using the execution infrastructure.

Next, FIGS. 25A and 25B are flowcharts showing the detailed steps of component setup information extraction processing included in the mockup.

The mockup design information analysis part 110 determines whether or not the execution architecture definition information 1760 exists in the input screen mockup storage part 170 (Step 2101). When the execution architecture definition information 1760 does not exist (Step 2101: No), Steps 2102 and 2103 are skipped.

When the execution architecture definition information 1760 does exist (Step 2101: Yes), the execution-target architecture setup analysis part 117 references the execution architecture definition information 1760, and extracts the execution architecture setup information 1540 (refer to FIG. 18A) from the execution architecture definition information 1760 (Step 2102). The execution architecture setup information 1540 extracted here is stored in the architecture information storage part 154.

The execution-target architecture setup analysis part 117 references the code fragment for interface generation 1640 (refer to FIG. 11), and determines whether or not the execution architecture definition information 1760 can be supported by the system (Step 2103). For example, the execution-target architecture setup analysis part 117 makes a determination in accordance with whether or not a combination of client and server definitions described in the architecture execution infrastructure setup 1761 of the inputted execution architecture definition or the detailed component allocation setup 1864 exist in the client-side interface infrastructure 1641 and the server-side interface infrastructure 1642.

In a case where to the determination of Step 2103 is that the execution architecture definition information 1760 cannot be supported by the system (Step 2103: No), the system 100 outputs a prescribed error message name and so forth, and ends the processing (Step 2121).

In a case where to the execution architecture definition information 1760 can be supported by the system (Step 2103: Yes), the screen mockup analysis part 111 identifies the language being used by the screen mockup program 1720 (Step 2104). For example, the screen mockup analysis part 111 identifies the screen mockup development language from characteristics information, such as the program file extension and file header of the screen mockup program 1720. The information denoting the development language identified here is stored in the screen mockup extraction information storage part 151.

The screen mockup analysis part 111 references the component code fragment group by architecture 1630 (refer to FIG. 10), and determines whether or not the development language identified here is a language supported by the system (Step 2105). For example, the determination as to whether or not the development language can be supported by the system may be made in accordance with whether or not the screen mockup development language identified in Step 2104 exists in the execution infrastructure 1633. When the screen mockup development language here is not supported by the system (Step 2105: No), a prescribed error message name is issued and the processing is ended (Step 2121).

Next, steps 2107 through 2110, which will be explained hereinbelow, are repeatedly executed with respect to all the screen mockup programs 1720 stored in the input screen mockup storage part 170 (Step 2106).

The screen mockup analysis part 111 reads the processing-target screen mockup program 1720 from the input screen mockup storage part 170 (Step 2107).

The data structure extraction part 112 extracts a data structure 1510 from the processing-target screen mockup program 1720, and stores this data structure 1510 in the screen mockup extraction information storage part 151 (Step 2108).

The trigger event extraction part 113 extracts a trigger event 1517 from the processing-target screen layout 1710, and stored this trigger event 1517 in the screen mockup extraction information storage part 151 (Step 2109).

The user-appended information extraction part 116 extracts a program code, which was uniquely defined by the developer, from the processing-target screen layout 1710, and stores this uniquely-defined program code in the user-appended information storage part 153 (Step 2110).

When the above processing has ended for all the screen mockup programs 1720, the component setup generation part 120 repeatedly executes steps 2113 through 2120, which will be explained hereinbelow, with respect to all the component setup files 1730 in the input screen mockup storage part 170 (Step 2111). In accordance with this, configuration component setup information 1520 comprising the screen mockup is extracted from the component setup files 1730.

The component setup information extraction part 114 reads the component setup file 1730, which constitutes the processing-target, from the input screen mockup storage part 170 (Step 2112).

Then, the component setup information extraction part 114 determines whether or not the processing-target component setup file 1730 satisfies the attributes required for component setup (Step 2113).

In a case where the processing-target component setup file 1730 does not satisfy the attributes required for component setup (Step 2113: No), the system 100 outputs prescribed information indicating that the setup information is insufficient, and notifies the developer (Step 2114).

In a case where the processing-target component setup file 1730 satisfies the attributes required for component setup (Step 2113: Yes), the component setup information extraction part 114 references the component setup attribute definition 1620 and extracts the configuration component setup information 1520 (refer to FIG. 15) from the processing-target component setup file 1730 (Step 2115).

The component information extraction part 114 verifies whether or not the configuration component setup information 1520 extracted here lacks inconsistencies and is valid (Step 2116).

The component information extraction part 114, in a case where the configuration component setup information 1520 is inconsistent (Step 2117: No), outputs prescribed information indicating that an inconsistency has been detected, and informs the developer (Step 2118).

The component information extraction part 114 stores the configuration component setup information 1520 extracted in Step 2115 in the mockup configuration component information storage part 152 (Step 2119). In a case where an inconsistency has been detected in Step 2116, the inconsistent information is written together with the configuration component setup information 1520.

The user-appended information extraction part 116 extracts a customer requirement (user-appended information) 1737 from the component setup file, and writes this customer requirement 1737 to the user-appended information storage part 153 (Step 2120). When the component type 1731 described in the processing-target component setup file 1730 is an undefined component, which is not configured in the component setup attribute definition 1620, the information described in the processing-target component setup file 1730 is stored in all the user-appended information storage parts 153.

In accordance with this, desired information is extracted from the input screen mockup data inputted by the developer.

Next, FIG. 26 is a flowchart showing the processing steps for generating a component setup corresponding to the execution architecture.

The target architecture supplementation part 121 references the architecture information storage part 154, and determines whether or not the execution architecture setup information 1540 corresponding to the developer-specified execution architecture definition information 1760 exists (Step 2201).

When the execution architecture setup information 1540 does not exist (Step 2201: No), the target architecture supplementation part 121 decides to execute a program using the mockup execution architecture, and configures all the components with respect to the architecture executed on the client (Step 2202). The architecture language uses the screen mockup development language extracted in Step 2104 by reading it from the screen mockup extraction information storage part 151.

The component setup supplementation part 123 applies the processing of Steps 2204 through 2210 to each component of the configuration component setup information 1520 stored in the mockup configuration component information storage part 152 (Step 2203).

The component setup supplementation part 123 reads information related to one component from the mockup configuration component information storage part 152 (Step 2204).

The component setup supplementation part 123 uses the component type 1522 of the target component read in Step 2204 as a key, references the component list 1610, and acquires the component type 1613. When the component type 1613 acquired here is not valid, the processing moves to Step 2208 (Step 2205: No).

When a valid component type 1613 is able to be acquired (Step 2205: Yes), the component setup supplementation part 123 supplements a prescribed default value with respect to an item, for which the attribute value 1524 is not provide, for the targeted component (Step 2206). As has already been explained, the target architecture supplementation part 121 references the component setup attribute definition 1620, identifies the default value 1625 of the corresponding item, and supplements this default value 1625.

The component setup supplementation part 123 also determines whether or not values have been configured in all of the mission-critical items for which the mission-critical flag 1626 has been set in the component setup attribute definition 1620 with respect to the targeted component (Step 2207).

When it is not possible to acquire a valid component type 1613 in Step 2205, and a mission-critical item has not been configured in Step 2207, the component program code can be automatically generated in this system, resulting in the component type 1522 being configured to “other” (Step 2208).

The component execution architecture decision part 130, while referencing the architecture information storage part 154 and the component code fragment group by architecture 1630, selects a program code fragment to be used in the automatic generation of a program code for the targeted component (Step 2209). Selecting the program code fragment, for example, identifies the allocation location at execution 1632, the execution infrastructure 1633, and the program code fragment storage location 1634.

The component execution architecture decision part 130 adds the allocation location at execution 1632, the execution infrastructure 1633, and the program code fragment storage location 1634 identified in Step 2209 to the configuration component setup information 1520 as the execution architecture 1525 and the code fragment storage location 1525, and writes this information 1632, 1633, and 1634 back to the mockup configuration component information storage part 152 (Step 2210).

The embodiment of the present invention described hereinabove is an example for explaining the present invention, and does not purport to limit the scope of the present invention solely to this embodiment. A person with ordinary skill in the art will be able to put the present invention into practice using a variety of other modes without departing from the gist of the present invention.

What is claimed is:

1. An automatic program generation device, comprising:
means for storing mockup data, which comprises a mockup program for displaying a screen, a component type of a component invoked from the screen, and attribute data for configuring in a component of the component type;
means for storing component data, which comprises component specifications for multiple component types;
means for generating, on the basis of the mockup data and the component data, design information for a component invoked from the screen;
means for storing information, which specifies an execution architecture;
means for configuring, on the basis of information specifying the execution architecture, a program execution infrastructure corresponding to the specified execution architecture;
means for storing a program code fragment in accordance with program execution infrastructure; and
means for selecting, on the basis of the component design information, a program code fragment, which operates on the configured program execution infrastructure, and generating a program code by configuring the attribute data in the selected program code fragment.

2. An automatic program generation device according to claim 1, wherein, when information specifying the execution architecture does not exist, the program execution infrastructure is determined on the basis of a predetermined mockup execution architecture.

3. An automatic program generation device according to claim 2, wherein the component data comprises a default value of an attribute value, which is configured in a component of each component type, and
when the attribute data is not included in the mockup data, the means for generating the program code configures the default value in the selected program code fragment.

4. An automatic program generation device according to claim 3, further comprising:
means for extracting from the mockup data a description related to a function, which is unable to be realized by any of multiple component types included in the component data,
wherein the means for generating the program code includes the extracted description in a program code such that the extracted description is outputted when a component invocation has been executed from the screen.

5. An automatic program generation device according to claim 2, further comprising:
a mockup development environment for generating the mockup data; and
a mockup review environment for operating a program code generated by the means for generating the program code and the mockup program.

6. An automatic program generation method performed by a computer, which comprises means for storing component data comprising component specifications of multiple component types, and means for storing a program code fragment by program execution infrastructure,
the automatic program generation method comprising the steps of:
storing mockup data, which comprises a mockup program for displaying a screen, a component type of a component invoked from the screen, and attribute data for configuring in a component of the component type;
storing information, which specifies an execution architecture;
generating, on the basis of the mockup data and the component data, design information for a component invoked from the screen;
configuring, on the basis of information specifying the execution architecture, a program execution infrastructure corresponding to the specified execution architecture; and
selecting, on the basis of the component design information, a program code fragment, which operates on the configured program execution infrastructure, and generating a program code by configuring the attribute data in the selected program code fragment.

7. An automatic program generation method according to claim 6, wherein, when information specifying the execution architecture does not exist, the program execution infrastructure is determined on the basis of a predetermined mockup execution architecture.

8. An automatic program generation method according to claim 7, wherein
the component data comprises a default value of an attribute value, which is configured in a component of each component type, and
when the attribute data is not included in the mockup data, a step of generating the program code configures the default value in the selected program code fragment.

9. An automatic program generation method according to claim 8, further comprising a step of extracting from the mockup data a description related to a function, which is unable to be realized by any of multiple component types included in the component data,
wherein in a step of generating the program code, the extracted description is included in a program code such that the extracted description is outputted when a component invocation has been executed from the screen.

10. An automatic program generation method according to claim 7, further comprising:
a mockup development environment for generating the mockup data; and
a mockup review environment for operating a program code generated in the step of generating the program code and the mockup program.
